(19) United States
(12) Patent Application Publication
(10) Pub. No.: US 2026/0197820 A1
(43) Pub. Date: Jul. 9, 2026

(54) METHOD, APPARATUS, AND SYSTEM FOR REDUCED BLIND DETECTION ON PDCCH WITH CANDIDATE SUBSETS

(71) Applicant: Huawei Technologies Co., Ltd., Shenzhen (CN)

(72) Inventors: Liqing Zhang, Ottawa (CA); Jianglei Ma, Ottawa (CA)

(21) Appl. No.: 19/536,663

(22) Filed: Feb. 11, 2026

Related U.S. Application Data
(63) Continuation of application No. PCT/CN2023/139259, filed on Dec. 15, 2023.
(60) Provisional application No. 63/519,065, filed on Aug. 11, 2023.

(51) Int. Cl. H04W 72/1263; H04W 72/23; H04W 72/542

(52) U.S. Cl. CPC H04W 72/1263; H04W 72/23; H04W 72/542

(57) ABSTRACT

Aspects of the present disclosure are directed to detecting a control channel used to transmit scheduling information in a wireless network. According to some embodiments of the present disclosure, an apparatus may receive configuration information including a plurality of control channel candidates (CCCs), wherein each subset of CCCs includes one or more CCCs and wherein each subset of CCCs is located within a time-frequency resource region of a control resource set (CORESET). The apparatus then may receive indication information including a scheduling message, wherein the indication information is carried by at least one CCC of a subset of CCCs from the one or more subsets of CCCs. The scheduling message includes scheduling resources for communication between the apparatus and another apparatus.

### CROSS-REFERENCE TO RELATED APPLICATIONS

This application is a continuation of International Patent Application No. PCT/CN2023/139259 filed on Dec. 15, 2023, which claims priority to and the benefit of U.S. Provisional Application No. 63/519,065 filed on Aug. 11, 2023, all of which are incorporated by reference herein in its entirety.

### TECHNICAL FIELD

The present disclosure relates generally to wireless communications, and in particular to methods, apparatuses, devices and systems for detecting or identifying a control channel used to transmit scheduling information in a wireless network that may reduce blind detection.

### BACKGROUND

One type of control signaling message in a wireless network is scheduling messages. Scheduling messages may include downlink (DL) control information (DCI) for (dynamically) scheduling or granting DL and/or uplink (UL) transmission time-frequency resources as well as other transmission related parameters in a DL control channel, such as a PDCCH (physical DL control channel). A PDCCH is a type of control channel and therefore, during a blind detection process when looking to detect a PDCCH, there may be multiple PDCCH candidates that may be considered. More generally, a PDCCH candidate may be considered as a control channel candidate (CCC). A PDCCH may be transmitted in a time-frequency resource region to carry a scheduling message. The time-frequency resource region used for a PDCCH may be pre-defined (e.g., using fixed or tabulated rules), determined based on system information (SI), broadcast, cell-group configured or UE-specific configured, for example, via RRC (radio resource control).

The time-frequency resource region may also be referred to as a (PDCCH) search space. A search space is the area in the downlink resource grid where one or more CCCs (i.e., PDCCH candidates) may be configured, where each PDCCH has a configured time-frequency location, and at least one of the PDCCHs may be used to carry out a control signaling at each PDCCH occasion (that a UE needs to monitor). In order for a UE to decode a PDCCH (or more generally a DCI), the UE has to figure out the exact value for location (e.g. one or more control channel element (CCE) index) of the PDCCH. Which PDCCH carries a signaling message at a PDCCH occasion is not known by the UE beforehand and, in most cases, a PDCCH that carries a signaling message may change dynamically. The UE may have to try to determine the PDCCH by detecting signals on one or more locations (i.e., the configured time-frequency resource) of the PDCCH over a predefined region that includes one or more PDCCH candidates based on trial and error (i.e., by trying different PDCCH candidates until the detection is successful). This method of decoding may be called blind detection.

PDCCH may be one of a set of PDCCH candidates defined over the time-frequency resource region. The set of PDCCH candidates is referred to as a control resource set (CORESET). There are often more than one PDCCH candidate in a CORESET for one UE (user equipment) or for a group of UEs. Each PDDCH candidate may be configured to have different encoding or redundant transmission versions to support the UE or group of UEs as the UE or group of UEs may be located in different geographical locations within a cell due to UE mobility and changing wireless channel environment. As a result, the UE or group of UEs may need to monitor scheduling messages received from the network and detect an incoming PDCCH through blind detection. A UE specific RNTI (Radio Network Temporary Identifier) or a group RNTI (e.g., semi-statically configured before communication) may be used to scramble the CRC (Cyclic Redundancy Check) of the incoming PDCCH payload (e.g., DCI).

In NR (new radio) networks, including 5G networks, for example, a CORESET may consist of 1, 2, or 3 symbols and one or more RBs (resource blocks) in a frequency domain. For example, there may be 24, 48 or 96 RBs for initial access procedures and up to 275 RBs for UE specific transmissions.

PDCCHs fall into three categories according to their application scenarios and functions: common PDCCHs, group common PDCCHs and UE-specific PDCCHs. A common PDCCH is used for transmitting common messages (such as system information such as remaining minimum system information (RMSI) or other system information (OSI)) and scheduling data (e.g., 4-step RACH (random access channel) Msg2/Msg4) before an RRC connection to the UE is established. A group common PDCCH is used for scheduling a group of UEs, e.g., scheduling the slot format indicator (SFI) for a UE group. A UE-specific PDCCH is used for scheduling the UE-specific data and power control information.

As a PDCCH may carry scheduling and control messages, which are critical communication messages in DL and/or UL transmission, it should be reliable enough to guarantee the reception at the receiving end (e.g., the UE side). An encoding or redundant transmission version may include schemes referred to as aggregation levels (AL). For example, in NR networks, an aggregation level of a PDCCH candidate may be any one of AL1 (aggregation level 1), AL2, AL4, AL8 and AL16, where a PDCCH candidate with AL1 may take one control channel element (CCE) (that consists of six physical resource blocks (PRBs)) as a time-frequency resource or the PDCCH channel resource. A PDCCH candidate with ALx (x>=1) may take x CCEs as a time-frequency resource or the PDCCH channel resource that is used to transmit a DCI. ALx>1 may refer to an AL that is equal to or greater than the aggregation level 1. “x” is an integer that may indicate the aggregation level or the number of CCEs allocated for a PDCCH. In other words, one CCE may be allocated as a time-frequency resource for a PDCCH with AL1, two CCEs may be allocated as a time-frequency resource for a PDCCH with AL2, four CCEs may be allocated as a time-frequency resource for a PDCCH with AL4, eight CCEs may be allocated as a time-frequency resource for a PDCCH with AL8, and sixteen CCEs may be allocated as a time-frequency resource for a PDCCH with AL16. A common PDCCH or group common PDCCH may be pre-defined, broadcast, cell-group configured or UE-specific configured with, for example, AL4, AL8 or AL16 while a UE-specific PDCCH may be configured with, for example, AL1, AL2, AL4, AL8 or AL16. An PDCCH with a higher aggregation level may use more resources to perform stronger channel encoding and hence, may be more reliable in DCI transmission. For example, AL16 may use 16 times the amount of the resources used by AL1, so a PDCCH with AL16 may have much more robust channel encoding resulting in more reliable transmission that a PDCCH with AL1.

One or more PDCCH candidates may be configured for each AL. If, for example, up to 8 PDCCH candidates are configured for each AL, there may be up to 40 PDCCH candidates that need to be monitored and blindly detected by the UE(s) for an incoming PDCCH upon transmission of each DCI. Blindly detecting an incoming PDCCH for each scheduling occasion may consume a lot of time and resources. Furthermore, the network may transmit unnecessary redundant signals, resulting in more power consumption, as a conservative way to achieve a reliable transmission of crucial control message if the network does not know the channel conditions or an accurate location of the UE.

As a result, there is a need to find ways of reducing the need for blind detection on PDCCH and of saving resources and power.

### SUMMARY

Aspects of the present disclosure provide methods, apparatuses, devices and systems to overcome the shortcomings described above, as well as specific methods, apparatuses, devices, and systems for detecting or identifying a control channel used to transmit scheduling information in a wireless network.

In some aspects of the present disclosure, there is provided a method including: receiving, at a receiving device, configuration information comprising one or more subsets of control channel candidates (CCCs), wherein each subset of CCCs includes one or more CCCs and wherein each subset of CCCs is located within a time-frequency resource region of a control resource set (CORESET); and receiving, at the receiving device, indication information including a scheduling message, wherein the indication information is carried by at least one CCC of a subset of CCCs from the one or more subsets of CCCs, and the scheduling message includes scheduling resources for communication between the receiving device and a transmitting device.

In some embodiments, receiving the indication information including the scheduling message includes performing detection of the at least one CCC among the subset of CCCs until the scheduling message is detected.

In some embodiments, the at least one CCC of the subset of CCCs is allocated in terms of one or more control channel elements (CCEs) of a group of CCEs, wherein: the group of CCEs is defined within the resource region of the CORESET; CCEs in the group of CCEs are mutually non-overlapping time-frequency resources; and each CCE has a CCE index.

In some embodiments, the at least one CCC includes one or more CCEs, each CCE having an index value, and wherein the number of CCEs in the CCC identifies an aggregation level (AL) of the CCC.

In some embodiments, each of the one or more subsets of CCCs is associated with an aggregation level (AL) group, wherein the AL group includes one or more different AL.

In some embodiments, the one or more subset of CCCs is pre-defined, broadcast, cell-group configured or UE-specific configured as a default subset to be used as an initial subset of CCCs for detection or for a fallback scenario, and when configured, the one or more subset of CCCs is configured by a higher-layer signaling or by dynamic signaling.

In some embodiments, the subset of CCCs is an active subset, and any CCC in the subset of CCCs is used for carrying the scheduling message.

In some embodiments, the subset of CCCs is predefined, higher-layer signaling configured or physical-layer signaling indicated to be an active subset.

In some embodiments, each of the one or more subsets of the CCCs is associated with an identifier to identify the subset of the CCCs.

In some embodiments, each CCC is a physical downlink control channel (PDCCH) candidate.

In some embodiments, the indication information is downlink control information (DCI).

In some embodiments, the method further includes: receiving, by the receiving device, an indication to activate a second subset of CCCs from the one or more subsets of CCCs; and receiving, at the receiving device, a second indication information including a second scheduling message, wherein the indication information is carried by at least one CCC of the second subset of CCCs, and the scheduling message includes scheduling resources for communication between the receiving device and the transmitting device.

In some embodiments, upon receiving the second subset of CCCs, which is different from the subset of CCCs, after a time duration from reception of the indication, switching, by the receiving device, from attempting to detect a channel candidate in the subset of CCCs to attempting to detect a channel candidate in the second subset of CCCs.

In some embodiments, the indication includes an identification of the time duration, which serves as a transition period to switch from attempting to detect the channel candidate in the subset of CCCs to attempting to detect the channel candidate in the second subset of CCCs.

In some embodiments, any of the one or more subsets of CCCs may be indicated as an active subset.

In some embodiments, any of the one or more subsets of CCCs may be indicated as a non-active subset.

In some embodiments, the indication may be a dynamic signaling, a higher-layer signaling, or a combination of the two.

In some embodiments, the dynamic signaling is DCI and the higher-layer signaling is at least one of radio resource control signaling (RRC) or media access control-control element (MAC-CE).

In some embodiments, the method further includes: receiving, by the receiving device, signaling information, the signaling information including information that includes a search rule; and performing detection of the at least one CCC among the subset of CCCs in an order based on the search rule.

In some embodiments, the signaling information is dynamic signaling, a higher-layer signaling, or a combination of the two.

In some embodiments, the dynamic signaling is DCI and the higher-layer signaling is at least one of RRC or MAC-CE.

In some embodiments, information in the search rule is arranged in the order of: a CCE index first, and an identification of an AL second; or an indication of an AL first, and a CCE index second.

In some embodiments, the method further includes: receiving, at the receiving device, a reference signal; performing measurement, at the receiving device, of the reference signal; sending, to a remote device, an identification of a third subset of the CCCs based on the measured reference signal, so that the remote device may use the third subset of CCCs to communication with the receiving device.

In some embodiments, the performing measurement of the reference signal includes measuring at least one of Reference Signal Received Power (RSRP), Reference Signal Received Quality (RSRQ), Signal-to-Noise Ratio (SNR) or Signal-to-Interference-plus-Noise Ratio (SINR).

In some embodiments, the reference signal is a channel state indicator reference signal (CSI-RS), synchronization signal block (SSB), phase tracking reference signal (PTRS), sounding reference signal (SRS).

In some embodiments, the identification of the subset of the CCCs is sent by RRC signaling, MAC-CE signaling, or DCI signaling.

In some embodiments, the CCC includes 2ⁿ control channel elements, wherein n=0 to N, where N is an integer.

In some aspects of the present disclosure, there is provided an apparatus in a wireless network including a processor and a computer-readable medium. The computer-readable medium has stored thereon, computer executable instructions, that when executed cause the apparatus to perform methods as described above.

In some aspects of the present disclosure, there is provided a method including: transmitting, at a transmitting device, configuration information including a plurality of CCCs, wherein each subset of CCCs includes one or more CCCs and wherein each subset of CCCs is located within a time-frequency resource region of a CORESET; and transmitting, at a transmitting device, indication information including a scheduling information, wherein the indication information is carried by at least one CCC of a subset of CCCs from the one or more subsets of CCCs, and the scheduling message includes scheduling resources for communication between the transmitting device and a receiving device.

In some embodiments, the at least one CCC of the subset of CCCs is allocated in terms of one or more control channel elements (CCEs) of a group of CCEs, wherein: the group of CCEs is defined within the resource region of the CORESET; CCEs in the group of CCEs are mutually non-overlapping time-frequency resources; and each CCE has a CCE index.

In some embodiments, the one or more subset of CCCs is configured as a default subset to be used as an initial subset of CCCs for detection or for a fallback scenario, and when configured, the one or more subset of CCCs is configured by a higher-layer signaling or by dynamic signaling.

In some embodiments, each subset of CCCs has an associated index.

In some embodiments, each of the one or more subsets of CCCs is associated with an aggregation level (AL) group, wherein the AL group includes one or more different AL.

In some embodiments, the subset of CCCs is an active subset, and any CCC in the subset of CCCs is used for carrying the scheduling message.

In some embodiments, the subset of CCCs is predefined to be an active subset.

In some embodiments, the method further includes transmitting, at a transmitting device, an index identifying a particular subset of CCCs to be used by the receiving device for performing detection.

In some embodiments, the index identifying the particular subset of control channel candidates is transmitted by RRC signaling, MAC-CE signaling, or DCI signaling.

In some embodiments, the method further includes transmitting, at a transmitting device, an indication of an ordering of the CCCs in the subset of CCCs to be used by the receiving device for performing detection.

In some embodiments, the indication of the ordering is transmitted by RRC signaling, MAC-CE signaling, or DCI signaling.

In some embodiments, the indication of the ordering is associated with at least one of: a CCE index; or an index corresponding to a CCC within the subset of CCCs.

In some embodiments, the method further includes: transmitting, at a transmitting device, a reference signal for measurement at a remote receiving device; receiving, from the remote receiving device, an identification of the subset of CCCs based on the reference signal measured by the remote receiving device, enabling at least one CCC the subset of CCCs to be used to send the signal on at least one CCC.

In some embodiments, the reference signal is a channel state indicator reference signal (CSI-RS), synchronization signal block (SSB), phase tracking reference signal (PTRS), sounding reference signal (SRS).

In some embodiments, the identification of the subset of CCCs is received by RRC signaling, MAC-CE signaling, or DCI signaling.

In some embodiments, the CCC includes 2ⁿ control channel elements, wherein n=0 to N, where N is an integer.

In some aspects of the present disclosure, there is provided an apparatus in a wireless network including a processor and a computer-readable medium. The computer-readable medium has stored thereon, computer executable instructions, that when executed cause the apparatus to perform methods as described above.

In some aspects of the present disclosure, there is provided a non-transitory computer readable storage medium, wherein the computer readable storage medium stores instructions that, when executed by a processor of an apparatus, enable the apparatus to perform methods as described above.

According to an aspect of the present disclosure, there is provided a device in a wireless network. The device includes a receiving unit configured to receive configuration information comprising one or more subsets of control channel candidates (CCCs), wherein each subset of CCCs includes one or more CCCs and wherein each subset of CCCs is located within a time-frequency resource region of a control resource set (CORESET); and to receive indication information including a scheduling message, wherein the indication information is carried by at least one CCC of a subset of CCCs from the one or more subsets of CCCs, and the scheduling message includes scheduling resources for communication between the receiving device and a transmitting device. The device further includes a transmitting unit configured to transmit configuration information including a plurality of CCCs, wherein each subset of CCCs includes one or more CCCs and wherein each subset of CCCs is located within a time-frequency resource region of a CORESET; and to transmit indication information including a scheduling information, wherein the indication information is carried by at least one CCC of a subset of CCCs from the one or more subsets of CCCs, and the scheduling message includes scheduling resources for communication between the transmitting device and a receiving device.

In some aspects of the present disclosure, there is provided a device configured to perform the method according to any of the methods mentioned in this disclosure.

In some aspects of the present disclosure, there is provided a processor configured to execute instructions to cause a device to perform any of the methods mentioned in this disclosure.

In some aspects of the present disclosure, there is provided an integrated circuit configured to perform the method according to any of the methods mentioned in this disclosure.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the present disclosure may occur.

FIG. 2 is another schematic diagram of a communication system in which embodiments of the present disclosure may occur.

FIG. 3 is a block diagram illustrating units or modules in a device in which embodiments of the present disclosure may occur.

FIG. 4 is a block diagram illustrating units or modules in a device in which embodiments of the present disclosure may occur.

FIG. 5 illustrates an example arrangement of control channel candidates at different aggregation levels (ALs) where the time frequency resources carrying the control channel candidates may be overlapped, in accordance with embodiments of the present disclosure.

FIG. 6 illustrates a first example representation of physical downlink control channel (PDCCH) candidate subsets that are configurable, in accordance with embodiments of the present disclosure.

FIG. 7 illustrates a second example representation of PDCCH candidate subsets that are configurable, in accordance with embodiments of the present disclosure.

FIG. 8 illustrates a third example representation of PDCCH candidate subsets that are configurable, in accordance with embodiments of the present disclosure.

FIG. 9 illustrates an example representation of PDCCH candidate usage priority in a subset with AL ascending order, in accordance with embodiments of the present disclosure.

FIG. 10 illustrates an example representation of PDCCH candidate usage priority in a subset with AL ascending order, in accordance with embodiments of the present disclosure.

FIG. 11 illustrates a first example representation of a priority search of PDCCH candidates, in accordance with embodiments of the present disclosure.

FIG. 12 illustrates a second example representation of a priority search of PDCCH candidates, in accordance with embodiments of the present disclosure.

FIG. 13 illustrates a third example representation of a priority search of PDCCH candidates, in accordance with embodiments of the present disclosure.

FIG. 14 illustrates a fourth example representation of a priority search of PDCCH candidates, in accordance with embodiments of the present disclosure.

FIG. 15A illustrates an example mapping between a channel measurement and a group of AL(s) for physical downlink control channel (PDCCH) transmission, in accordance with embodiments of the present disclosure.

FIG. 15B illustrates an example mapping between a preamble group (or a preamble subset) and a channel measurement range, in accordance with embodiments of the present disclosure.

FIG. 15C illustrates an example mapping between a preamble group (or a preamble subset) and a group of AL(s) for PDCCH transmission, in accordance with embodiments of the present disclosure.

FIG. 16 is a signal flow diagram illustrating an example method for detecting or identifying a control channel used to transmit scheduling information in a wireless network, in accordance with embodiments of the present disclosure.

### DETAILED DESCRIPTION OF THE ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure provide methods, apparatuses, devices and systems to overcome the shortcomings described above, as well as specific methods, apparatuses, devices, and systems for detecting or identifying a control channel (e.g., physical downlink control channel (PDCCH)) that may be used to transmit scheduling information in a wireless network. The methods, apparatuses, devices, and systems proposed in the present disclosure may save resources, avoid unnecessary redundant signals, reduce a number of blind detections on the control channel, and/or reduce power consumption. According to some embodiments of the present disclosure, an apparatus (e.g., user equipment (UE)) may receive, from a device (e.g., base station), configuration information including one or more subsets of control channel candidates (CCCs), wherein each subset of CCCs includes one or more CCCs and wherein each subset of CCCs is located within a time-frequency resource region of a control resource set (CORESET). The apparatus then may receive indication information including a scheduling message, wherein the indication information is carried by at least one CCC of a subset of CCCs from the one or more subsets of CCCs. The scheduling message includes scheduling resources for communication between the receiving device and a transmitting device. Some embodiments may involve the apparatus performing blind detection of the at least one CCC among the subset of CCCs until the scheduling message is detected. Because the apparatus has received configuration information including various subsets of CCCs, the apparatus may be able to perform less blind detecting if the apparatus detects CCCs in a CCC subset that is less than all of the possible CCCs. In some embodiments, the apparatus may receive receiving signaling information, wherein the signaling information includes a search rule and then the apparatus performs detection of the at least one CCC among the subset of CCCs in an order based on the search rule. While the above steps are described from the perspective an apparatus receiving from a device, it is to be understood that steps could be described from the perspective of the device transmitting to the apparatus as well.

References are made throughout this application to PDCCHs and PDCCH candidates. A PDCCH is a type of control channel and a PDCCH candidate is a type of CCC. These terms are used interchangeably within this application and it is to be understood that any reference made to a PDCCH may apply to control channels in general and vice verso. Similarly, any reference made to PDCCH candidates may apply to CCCs in general and vice versa.

This application may be applied to 6G or future generation communications system. An exemplary 6G system is illustrated below.

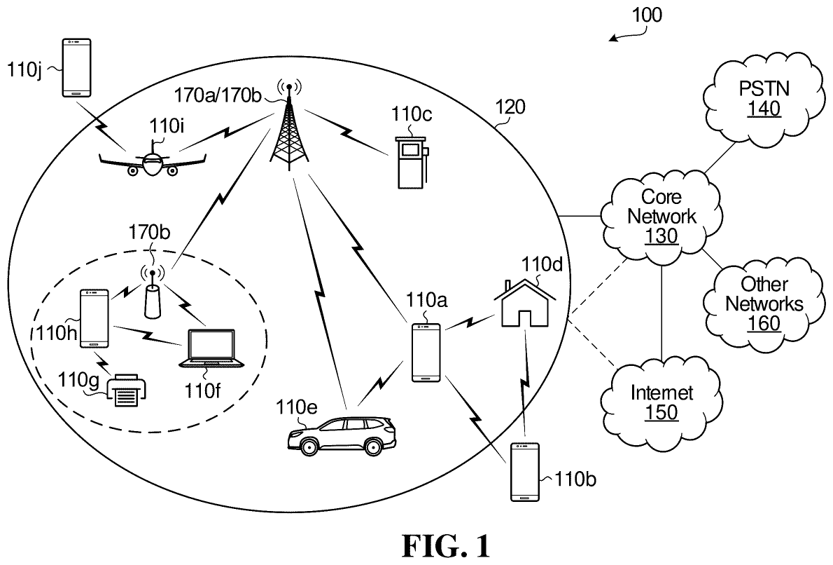

FIG. 1 illustrates an example communication system in which embodiments of the present disclosure may occur.

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

In this application, a base station is an example of network node 170, and user equipment (UE) is an example of ED 110.

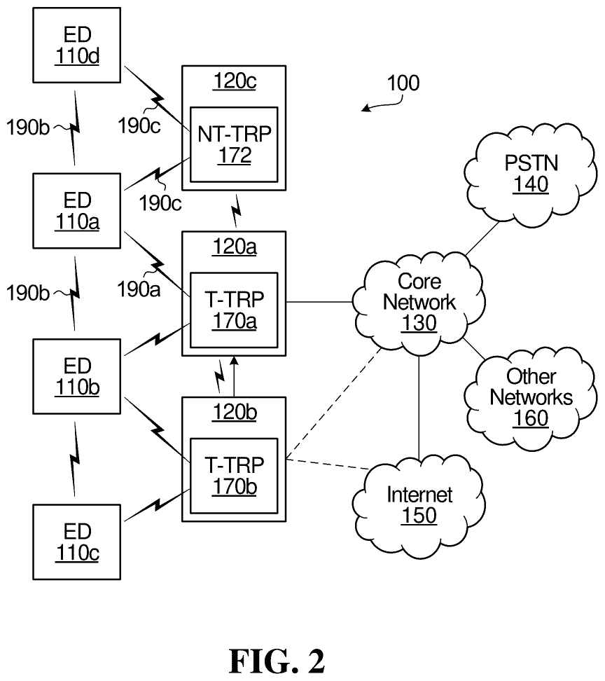

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system may result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c may enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

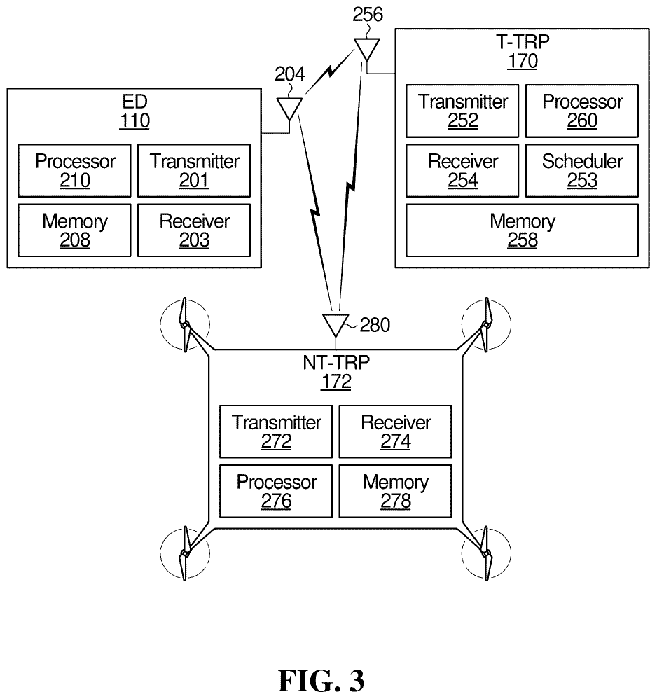

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 may be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or implementations described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the implementation, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some implementations, the processor 276 implements the transmit beamforming and/or receive beamforming based on the indication of beam direction, e.g. beam angle information (BAI), received from T-TRP 170. In some implementations, the processor 210 may perform operations relating to network access (e.g. initial access) and/or downlink synchronization, such as operations relating to detecting a synchronization sequence, decoding and obtaining the system information, etc. In some implementations, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some implementations, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some implementations, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some implementations, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some implementations, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some implementations, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or implementations described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some implementations, the processor 276 implements the transmit beamforming and/or receive beamforming based on beam direction information (e.g. BAI) received from T-TRP 170. In some implementations, the processor 276 may generate signaling, e.g. to configure one or more parameters of the ED 110. In some implementations, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some implementations, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

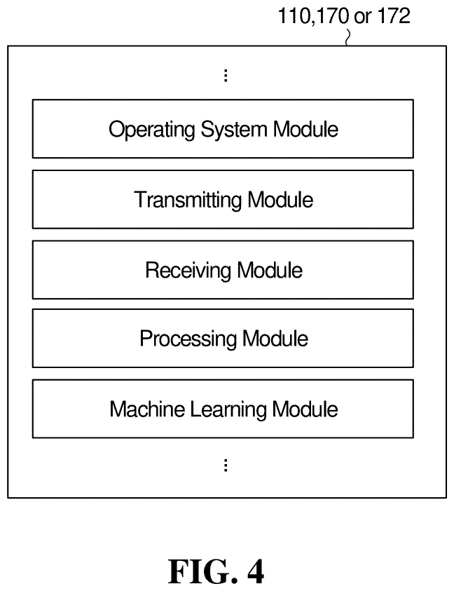

One or more steps of the implementation methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some implementations, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, may be configured. In some implementations, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device may both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case, the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Implementations of flexible frame structures include different parameters that may be configurable, e.g. frame length, subframe length, symbol block length, etc. A non-exhaustive list of possible configurable parameters in some implementations of a flexible frame structure include the followings.

(1) Frame: The frame length need not be limited to 10 ms, and the frame length may be configurable and change over time. In some implementations, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.

(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some implementations, if a subframe is not needed in a particular scenario, then the subframe length may be defined to be the same as the frame length or not defined.

(3) Slot configuration: A slot might or might not be defined in the flexible frame structure, depending upon the implementation. In frames in which a slot is defined, then the definition of a slot (e.g. in time duration and/or in number of symbol blocks) may be configurable. In one implementation, the slot configuration is common to all UEs or a group of UEs. For this case, the slot configuration information may be transmitted to UEs in a broadcast channel or common control channel(s). In other implementations, the slot configuration may be UE specific, in which case the slot configuration information may be transmitted in a UE-specific control channel. In some implementations, the slot configuration signaling may be transmitted together with frame configuration signaling and/or subframe configuration signaling. In other implementations, the slot configuration may be transmitted independently from the frame configuration signaling and/or subframe configuration signaling. In general, the slot configuration may be system common, base station common, UE group common, or UE specific.

(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures may be used with different SCSs.

(5) Flexible transmission duration of basic transmission unit: The basic transmission unit may be a symbol block (alternatively called a symbol), which in general includes a redundancy portion (referred to as the CP) and an information (e.g. data) portion, although in some implementations the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some implementations, the symbol block length may be adjusted according to: channel condition (e.g. multi-path delay, Doppler); and/or latency requirement; and/or available time duration. As another example, a symbol block length may be adjusted to fit an available time duration in the frame.

(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some implementations, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some implementations, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other implementations, a BWP may have one or more carriers, e.g. a BWP may have a bandwidth of 40 MHz and consists of two adjacent contiguous carriers, where each carrier has a bandwidth of 20 MHz. In some implementations, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some implementations, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard. It is noted that DCI may refer to downlink (DL) control information.

In the present disclosure, terms “apparatus” and “device” are simply used to more easily distinguish between the entities. A non-limiting example of the apparatus is a user equipment (UE), or any other terminal devices or elements therein. A non-limiting example of the device is a base station, or any other network side devices or components therein.

A legacy network, such as an NR network, may have a common search space (CSS) with AL4, AL8 and AL16, where each AL may have up to 8 PDCCH candidates that may be configured. Therefore, there may be up to a total of 24 PDCCH candidates for the three ALs configured with a CSS. Such a network may also have a UE specific search space (USS) with AL1, AL2, AL4, AL8 and AL16, where each AL may have up to 8 PDCCH candidates that may be configured. Therefore, there may be a total of up to 40 PDCCH candidates for the five ALs configured with a USS. Among multiple PDCCH candidates configured with CSS or USS, only one PDCCH candidate may be used for each DCI transmission.

As mentioned above, a search space refers is the area in a downlink resource grid where a PDCCH may be carried. CSSs and USSs are search spaces on PDCCH candidates for cell based (e.g., a group of UEs in the cell) and UE specific configurations respectively. A USS is a dedicated area in a downlink resource grid for each specific UE. A USS carries control information specific to a particular UE and is monitored by at least one UE in a cell. A CSS is the search space that every UE in a cell may need to search for a signaling message, e.g., for a signaling message that is applied to every UE before dedicated channel is established for a specific UE. A CSS carries the common control information and is monitored by all UEs in a cell. The search space is defined, including one CORESET as one unit area in defining multiple PDCCH candidates, by how long (e.g., how many slots or frames) the PDCCH detection will last and by how many PDCCHs there are per slot and which symbol(s) in a slot are used for PDCCH transmissions, etc.

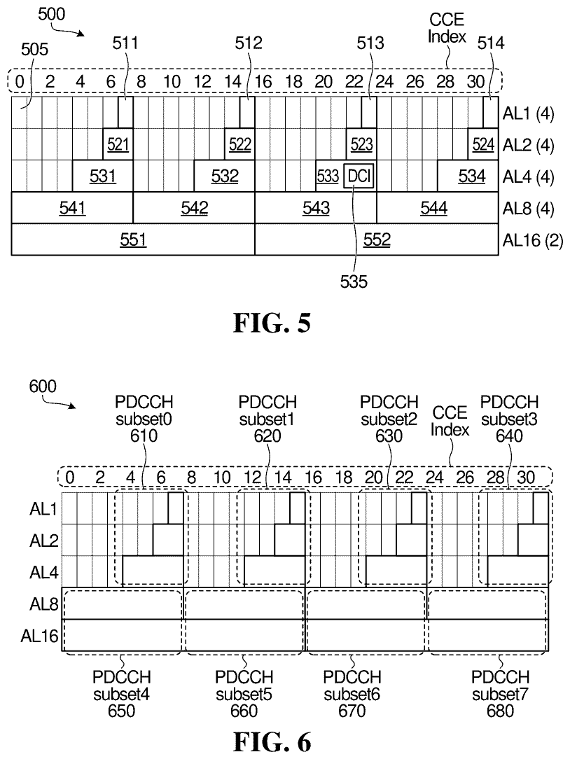

For example, for a UE configuration with a CORESET having a frequency resource of 96 physical resource blocks, a time resource of 2 symbols and an aggregation configuration with AL1(4)/AL2(4)/AL4(4)/AL8(4)/AL16(2) (where ALx(y) means aggregation level x with y PDCCH candidates) there would be a total of 18 PDCCH candidates. From a UE reception perspective, the UE has to perform blind detection for a (dynamic) scheduling (i.e., DCI signaling) occasion or PDCCH monitoring occasion amongst 18 PDCCH candidates, though only one PDCCH may be used for the actual transmission that carries the scheduling (i.e., DCI signaling), as shown in FIG. 5.

FIG. 5 illustrates an example arrangement of control channel candidates at different ALs, where the time-frequency resources carrying the control channel candidates may be overlapped. Specifically, FIG. 5 illustrates an example of PDCCH candidates with 5 aggregation levels, where each PDCCH candidate may be carried in a time-frequency resource represented by one or more control channel elements (CCEs) (each CCE may be identified by a pre-defined or configured CCE index), and at least one PDCCH candidate may be used as a (DL) control channel to carry a DCI or scheduling information in a scheduling occasion. However, it is noted that the example shown in FIG. 5 may be similarly applicable for other type of control channels. As noted above, in FIG. 5, ALx(y) means aggregation level “x” with “y” control channel candidates (e.g., PDCCH candidates) that are configured.

Referring to FIG. 5, a PDCCH region 500 (i.e., time-frequency resources for transmission) is represented by a plurality of CCEs, for example a CCE 505, that may be used to transmit scheduling information from a device (e.g., base station) to an apparatus (e.g., UE). The scheduling information may be DCI or other type of scheduling information. The apparatus receiving the control channels, for example a UE, may search for time-frequency resources of a control channel represented by one or more CCEs that may be used for transmission of the scheduling information over the control channel.

Referring to FIG. 5, the numbers 0, 2, 4, . . . , 30 on top of FIG. 5 indicate control channel element (CCE) indices. The CCEs may be formed by dividing the CORESET time-frequency resources or CORESET resource region into non-overlapping resource units, and each CCE may be identified by an (designated, predefined or configured) index. As shown in FIG. 5, there are CCEs with CCE indices from 0 to 31 in the PDCCH region 500. The CCE index indicates the CCE number to present a resource unit at which a control channel (e.g., PDCCH) may be allocated for transmission. FIG. 5 illustrates multiple PDCCH candidates and multiple (indexed) CCEs. One or more of these (indexed) CCE(s) may be allocated to each of the multiple PDCCH candidates as channel time-frequency resources, and the number of CCEs allocated to each PDCCH channel candidate may be indicative of a respective aggregation level (AL). As a result, the time-frequency resources allocated to the different PDCCH candidates may be (partially) overlapping (on one or more CCEs).

As shown in FIG. 5, there are a total of 18 PDCCH candidates with varying aggregation levels. Specifically, there are 4 PDCCH candidates having AL1, 4 PDCCH candidates having AL2, 4 PDCCH candidates having AL4, 4 PDCCH candidates having AL8, and 2 PDCCH candidates having AL16.

The various aggregation levels AL1, AL2, etc., represent different ways that a subset of 32 CCEs may be allocated to PDCCH candidates as transmission resources.

For the set of 32 CCEs, in the case of using AL1, a PDCCH candidate 511, 512, 513, 514 consisting of a single CCE is allocated in each group of 8 CCEs in the total of 32 CCEs in this configuration. In other words, each of the PDCCH candidates 511, 512, 513, and 514 uses a single (indexed) CCE as its time-frequency resource. In FIG. 5, the PDCCH candidate 511 having AL1 may include a CCE with an index 7, the PDCCH candidate 512 having AL1 may include a CCE with an index 15, the PDCCH candidate 513 having AL1 may include a CCE with an index 23, and the PDCCH candidate 514 having AL1 may include a CCE with an index 31.

For the same set of 32 CCEs, in the case of using AL2, a PDCCH candidate 521, 522, 523, 524 consisting of two CCEs is allocated in each group of 8 CCEs in the total of 32 CCEs in this configuration. In other words, each of the PDCCH candidates 521, 522, 523, and 524 uses two (indexed) CCEs as its time-frequency resource. In FIG. 5, the PDCCH candidate 521 having AL2 may include CCEs with indices 6 and 7, the PDCCH candidate 522 having AL2 may include CCEs with indices 14 and 15, the PDCCH candidate 523 having AL2 may include CCEs with indices 22 and 23, and the PDCCH candidate 524 having AL2 may include CCEs with indices 30 and 31.

For the same set of 32 CCEs, in the case of using AL4, a PDCCH candidate 531, 532, 533, 534 consisting of four CCEs is allocated in each group of 8 CCEs in the total of 32 CCEs in this configuration. In other words, each of the PDCCH candidates 531, 532, 533, and 534 uses four (indexed) CCEs as its time-frequency resource. In FIG. 5, the PDCCH candidate 531 having AL4 may include CCEs with indices 4 to 7, the PDCCH candidate 532 having AL4 may include CCEs with indices 12 to 15, the PDCCH candidate 533 having AL4 may include CCEs with indices 20 to 23, and the PDCCH candidate 534 having AL4 may include CCEs with indices 28 to 31.

For the same set of 32 CCEs, in the case of using AL8, a PDCCH candidate 541, 542, 543, 544 consisting of all eight CCEs is allocated in each group of 8 CCEs in the total of 32 CCEs in this configuration. In other words, each of the PDCCH candidates 541, 542, 543, and 544 uses eight (indexed) CCEs as its time-frequency resource. In FIG. 5, the PDCCH candidate 541 having AL8 may include CCEs with indices 1 to 7, the PDCCH candidate 542 having AL8 may include CCEs with indices 8 to 15, the PDCCH candidate 543 having AL8 may include CCEs with indices 20 to 23, and the PDCCH candidate 544 having AL8 may include CCEs with indices 24 to 31.

For the same set of 32 CCEs, in the case of using AL16, a PDCCH candidate 551, 552 consisting of 16 CCEs is allocated in two groups of 8 CCEs in the total of 32 CCEs in this configuration. In other words, each of the PDCCH candidate 551 and 552 uses allocated 16 (indexed) CCEs as its time-frequency resource. In FIG. 5, the PDCCH candidate 551 having AL4 may include CCEs with indices 0 to 15, and the PDCCH candidate 552 having AL16 may include CCEs with indices 16 to 31.

Among multiple PDCCH candidates, at least one PDCCH may be used for transmission of the scheduling information for the apparatus. In FIG. 5, the DCI 535 for scheduling a data transmission between the apparatus and the device may be carried over to the PDCCH candidate 533 occupying CCEs with indices 20 to 24. In other words, the device (e.g., base station) may transmit the DCI 535 to the apparatus (e.g., UE) over the PDCCH 533 including CCEs with indices 20 to 24.

If the apparatus is notified that the DCI is transmitted on a PDCCH candidate using at least an AL4, then the apparatus may be able to monitor (e.g. perform blind detections) PDCCH candidates 531, 532, 533, 534, 541, 542, 543, 544, 551 and 552 as opposed to monitoring all of the possible PDCCH candidates, thereby saving resources and potentially finding the DCI in a more timely manner due to the reduced amount of monitoring involved. Depending on how the UE performs blind detection, the DCI may be found sooner or later. For example, if the UE performs blind detection of all AL4 PDCCH candidates from left to right in FIG. 5, e.g. in the order of 531, 532, 533, 534, then the DCI will be found in a third detection attempt and the UE may not bother to detect PDCCH candidates 534, 541, 542, 543, 544, 551 and 552. However, with a different ordering of PDCCH candidate blind detections, such as starting with AL16, more blind detection attempts may be performed before the DCI is found in AL4 533. However, in either case, not all of the PDCCH candidates are being blind detected, only as many as necessary to find the DCI in AL4, AL8 and A16.

Current networks, such as NR networks, may use blind detections for each DCI reception or each PDCCH monitoring occasion to be performed over all PDCCH candidates that are configured which may not be necessary in all situations. The power and other resource consumption in current blind detection methods on PDCCH may be too high to be accepted in an energy efficient wireless network, such as a 6G network.

### PDCCH Candidate Subsets and Adaptation for Reduced PDCCH Blind Detection

As described above, PDCCH channels may be configured with multiple aggregation levels (e.g., from AL1, AL2, up to AL16) to support mobility of the UE and various wireless channel conditions. A UE may be mobile and, at any given point, may be in a different location within a BS (or a network). Also, the UE may experience varying wireless environments and channel conditions, such as, e.g., reference signal received power (RSRP), signal to interference-plus-noise ratio (SINR), etc. AL1 should be used only when the channel conditions are good (e.g., the UE is close to the BS and channel conditions are good) since it may not be as reliable as higher ALs under poor conditions. AL16 may be used when the channel conditions are poor (e.g., the UE is far from the BS or located around a cell boundary of the BS and/or the channel quality is poor).

Channel measurement(s) reported in a DL reference signal (RS)(s) received by a UE may allow for a more accurate decision on an appropriate aggregation level used for a PDCCH to reliably carry scheduling information or DCI. The channel measurement metrics may include one or more of e.g., RSRP, RSRQ (Reference Signal Received Quality), SINR, etc. An RSRP is the average power received from a single reference signal and its typical range is between −44 dbm (good) to −140 dbm (bad). An RSRQ indicates the quality of the received signal and its range is typically between −19.5 dB (bad) to −3 dB (good). An SINR is the signal-to-noise ratio of a given signal. The channel measurements can be made on DL and/or UL reference signals, e.g., a synchronization signal block (SSB), a channel state information reference signal (CSI-RS) or a sounding reference signal (SRS).

As an example, DL measurement metrics may indicate the channel conditions/quality and/or a distance between the US and the BS. The channel conditions and quality may be used to limit the number of PDCCH candidates applicable to reliably transmit a DCI. For example, a typical range of (average) RSRP may be, e.g., −40 dbm to −140 dbm. An RSRP of −40 dbm is an indication of an excellent channel condition, in which a PDCCH with AL1 may be able to delivery reliable transmission of a DCI to the UE, whereas an RSRP −140 dbm is an indication of a poor channel condition, in which a PDCCH with AL16 may be required to deliver reliable transmission of a DCI to the UE. An RSRQ indicates the quality of the received signal with its typical range being, e.g., −20 dB to 0 dB. An RSRQ of 0 dB is an indication of an excellent channel condition, in which a PDCCH with AL1 may be able to deliver reliable transmission of a DCI to the UE, whereas an RSRQ of −20 dB is an indication of a poor channel condition, in which a PDCCH with AL16 may be required to deliver reliable transmission of a DCI to the UE. As a result, a set of categorized measured channel conditions based on one or more of the measurement metrics can be associated with different groups of ALs that may be used in a PDCCH to deliver a DL control information (DCI) with a required reliability, where each group may comprise one or more ALs.

The multiple PDCCH candidates for a CORESET and search space configuration may comprise at least AL16 so as to prepare for the worst channel condition case, where the search space configuration provides detailed parameter configuration for PDCCH transmissions, e.g., how often to use the configured CORESET (as resource unit), how many slots and frames that such PDCCH channels are monitored, how many PDCCH occasions in a slot, etc. However, it is not effective if only one aggregation level option, AL16, is used in PDCCHs. Although AL16 will work for all channel conditions, it requires more resources and is too conservative to be used in all cases. Thus, usually multiple ALs can be used to balance or trade-off between resource utilization efficiency and transmission reliability. Lower ALs may be used for good channel conditions or/and when the UE is close to the BS, while higher ALs may be used for poor channel conditions or/and when the UE is close to cell boundary of the BS. Timely channel measurement conditions or/and a UE location with regard to the BS (or distance between the UE and the BS) may be important pieces of information so that proper AL(s) for PDCCH(s) may be used efficiently with a reliable DCI transmission over the PDCCH. Different ALs for PDCCH(s) to carry a DCI may be measured or calibrated by testing (e.g., field trial, lab testing) or simulation over varying channel conditions.

For a UE to reduce the amount of blind detection used for an actual PDCCH over possible PDCCH candidates, the number of PDCCH candidates to be monitored at each PDCCH monitoring occasion should be reduced. However, the PDCCH candidates use ALs that match the channel conditions of the UE. As such, a subset of PDCCH candidates is proposed based on one or more configured CORESETs and/or search spaces (SSs) (e.g., UE specific search space/USS, common search space/CSS).

Based on configured CORESET(s) and/or search space(s), the proposed scheme includes the following:
Predefining or/and configuring one or more sub-sets of PDCCH candidates with one or more (types of) ALs, where an AL may be applied to one or more PDCCH candidates.
The one or more ALs in one above sub-subset of PDCCH candidates may use part of these ALs, e.g., any group of AL(s) from the following groups may be used for a subset of PDCCH candidates.
   (AL1), (AL2), (AL4), (AL8), (AL16)
   (AL1, AL2), (AL2, AL4), (AL4, AL8), (AL8, AL16)
   (AL1, AL2, AL4), (AL2, AL4, AL8), (AL4, AL8, AL16)
   (AL1, AL2, AL4, AL8), (AL2, AL4, AL8, AL16)
   (AL1, AL2, AL4, AL8, AL16)
   Note that other ALs, such as AL32, AL64, etc., may also be applicable and involved in AL groups for some applications, such as e.g., sensing operations, remote data transmission, etc., possibly in future wireless networks.

The above AL groups may be predefined, preconfigured or configured. Each group of ALs may be mapped to channel conditions or quality, where the channel conditions and quality may be measured based on reference signals such as SSB, CSI-RS, phase tracking reference signal (PTRS), SRS, etc. In some embodiments, a BS may configure the measurement metric (e.g., RSPR, RSPQ, SiNR, channel quality indicator (CQI), etc.) and a UE may perform these measurements and send the results, as a CSI report, to the BS.

PDCCH candidate sub-sets, each with one group of ALs, may be predefined (e.g., which may be indicated in a communication standard), broadcast, cell-group configured or UE-specific configured by an RRC. PDCCH candidate sub-sets may be indexed, e.g., indexing one subset of PDCCH candidates with one group of AL(s) as set_pdcch(i), i=0, . . . , I−1, (where I is the total number of sub-sets of PDCCH candidates) where each subset of PDCCHs is defined with one group of AL(s) from a defined group of AL groups, such as is shown in FIG. 5.

In some embodiments, for a configured CORESET and search space configuration, a group of indexed CCEs may be determined and a plurality of PDCCH candidates may be determined based on the group indexed CCEs. For example, a PDCCH candidate from the plurality of PDCCH candidates may include (or be allocated) one or more CCEs as a time-frequency resource corresponding to one (AL1) or more CCEs (ALx, x>1), the time-frequency resource being a part of the total time-frequency resources in the configured CORESET. The one or more CCE(s) may be considered a PDCCH channel. Considering the plurality of PDCCH candidates, one or more subsets of PDCCH candidates may be configured (or constructed), where each subset, set_pdcch(i), (i being an integer index value) comprises one or more PDCCH candidates from the plurality of PDCCH candidates. At least one PDCCH candidate may be included in the subset, and/or at least one aggregation level (i.e., at least one CCE as channel time-frequency resource) may be associated with PDCCH candidate(s) in the subset. At least one subset of PDCCH candidates from the one or more subsets of PDCCH candidates may be configured or indicated as for active and/or default operation. Such one or more subsets of PDCCH candidates may be referred to as an active subset and/or a default subset, respectively. PDCCH candidate(s) in any subset of PDCCH candidates set for default operation may be used at the start of a communication, before any active subsets of PDCCH candidates are indicated, or during a timeout after active subsets of PDCCH candidates have been operational. At least one subset of PDCCH candidates from the one or more subsets of PDCCH candidates may be configured (or set) to active operation by an activation signaling or indication, where the activation signaling or indication may be higher-layer signaling such as radio resource control (RRC) and/or Layer 1 (L1) signaling such as Downlink Control Information (DCI). From a subset of PDCCH candidates set to active operation, at least one PDCCH candidate may be used to carry a scheduling information (e.g., DCI); thus a UE may monitor and detect the PDCCH candidates in this subset. At least one subset of PDCCH candidates from the one or more subsets of PDCCH candidates may be configured (or set) to non-active or silent operation by a de-activation signaling or indication, where the de-activation signaling or indication may be higher-layer signaling such as RRC or/and L1 signaling such as DCI. From a subset of PDCCH candidates set to non-active or silent operation, no PDCCH candidate may be used to carry a scheduling information (e.g., DCI); thus a UE may not monitor or detect the PDCCH candidates in this subset. Note that in this disclosure, “a subset of PDCCH candidates” may be interchangeably referred to as “a PDCCH candidate subset”.

During a certain time period, one subset of PDCCH candidates, set_pdcch(i), may be used as an active subset, and during another time period, the subset, set_pdcch(i) may not be inactive operation (or may be indicated to be non-active), while another of the subsets of PDCCH candidates, set_pdcch(j), (j being an integer index value) may be indicated to be active subset, where i<>j. Allowing for a switching of active operation between the two subsets of PDCCH candidates, there may be a time gap or grace period between the switching from using set_pdcch(i) to set_pdcch(j). Parameters related to a subset of PDCCH candidates (e.g., active/activation, non-active/deactivation, default, the gap, etc.) may be configured semi-statically (e.g., via RRC signaling or MAC control element (MAC CE)) or dynamically indicated (e.g., via DCI). An operation of switching between two subsets of PDCCH candidates may involve UE and/or network measurements on reference signals (RSs) and/or measurement reports from the UE, e.g., the UE reporting information pertaining to RSRP, RSRQ, CQI, SiNR, beam direction, carrier bands, etc.

### Priority Ordering on Usage of PDCCH Candidates in a Subset

A subset of PDCCH candidates may be further defined or configured with a priority ordering of the PDCCH candidates in the subset. The priority ordering may be used by a scheduler to schedule transmission and for a receiving UE to monitor and detect when the subset is activated (or become an active subset). As a result, a UE may try to detect a PDCCH over an active subset of PDCCH candidates based on the priority ordering. Such a scheme may enhance blind PDCCH detection even further.

At least one PDCCH candidate in a subset of PDCCH candidates may be configured as the initial usage (i.e., a usage with the highest priority) and a UE monitoring for a PDCCH occasion may try to detect the at least one PDCCH candidate first and other PDCCH candidates after, as needed. This may provide an efficient way to reduce the number of blind detections on PDCCH candidates. In some embodiments, to make ordering PDCCH candidates by priority in a subset easy, the PDCCH candidates in the subset may be indexed and the PDCCH candidates may be ordered starting with the PDCCH candidate having an index with the highest priority PDCCH candidate. As a result, a subset of PDCCH candidates and/or a PDCCH candidate in the subset may be indicated or configured in terms of their individual indexes for at least one of activation, deactivation, and/or switching for the PDCCH subset. Signaling of the priority ordering configuration or indication may be performed using one or more of RRC, MAC-CE, or DCI.

There are multiple possible embodiments to achieve the proposed goals or solutions, which are described generally above and some of which are detailed in the following examples.

### PDCCH Candidate Subsets

In this example, a plurality of PDCCH candidates may be used to provide one or more subsets of PDCCH candidates for given CORESET and search space configurations, where each subset of PDCCH candidates from the one or more subsets of PDCCH candidates may include one or more PDCCH candidates from the plurality of PDCCH candidates. Different subsets of PDCCH candidates among the one or more subsets of PDCCH candidates may or may not have overlapping PDCCH candidate(s). The one or more subsets of PDCCH candidates may be predefined (e.g., which may be indicated in a communication standard), broadcast, cell-group configured or UE-specific configured (e.g., by RRC, MAC-CE) or dynamically indicated (e.g., via DCI).

The one or more subsets of PDCCH candidates may be indexed, for example, by indexing a subset as set_pdcch(i), i=0, . . . , I−1 (i.e., I subsets of PDCCH candidates are predefined or configured), where set_pdcch(i) may include or be allocated one or more CCUs as channel resources, corresponding to one or more ALs. The subset of PDCCH candidates set_pdcch(i) among the one or more subsets of PDCCH candidates may be activated, deactivated or switching between active and non-active operation.

In Example 1 600, as shown in FIG. 6, PDCCH candidates are partitioned or grouped into eight PDCCH candidate subsets 610, 620, 630, 640, 650, 660, 670 and 680, indexed as PDCCH subset0 610 (for simplicity, a PDCCH candidate subset x is referred to as simply PDCCH subset x), PDCCH subset1 620, . . . , and PDCCH subset7 680, where PDCCH candidates in two PDCCH subsets may or may not be overlapping (i.e., there may be one or more PDCCH candidates which are common to both subsets), and at least one PDCCH subset may not take all available ALs, potentially reducing the number of detections necessary in determining a PDCCH.

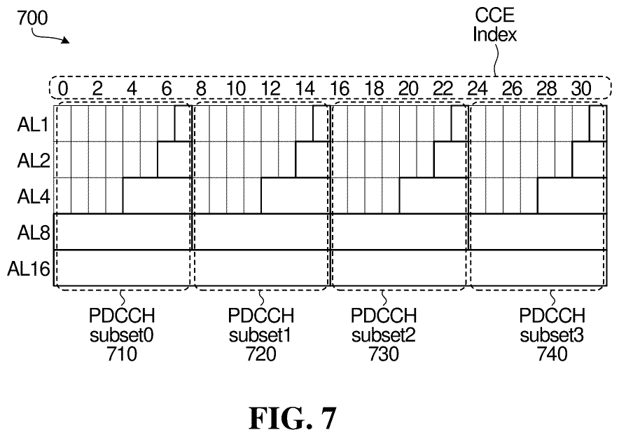

In Example 2 700, as shown in FIG. 7, PDCCH candidates are partitioned or grouped into four PDCCH candidate subsets, that are indexed as PDCCH subset0 710, PDCCH subset1 720, PDCCH subset 2 730 and PDCCH subset3 740, where PDCCH candidates in two PDCCH subsets may or may not be overlapping (i.e., there may be one or more PDCCH candidates which are common to both subsets), and at least one PDCCH subset may not take all available PDCCH candidates based on CORESET resource and/or search space configuration(s), thus potentially reducing the number of detections necessary in determining a PDCCH.

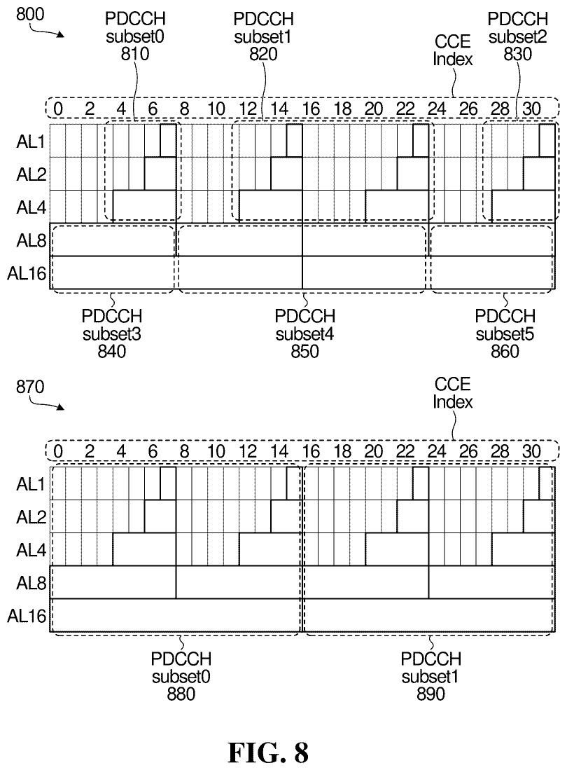

In Example 3 800, as shown in FIG. 8, PDCCH candidates are partitioned or grouped into one or more PDCCH candidate subsets, where different subsets may include different numbers of PDCCH candidates. In some cases, one subset may comprise all the available PDCCH candidates. The candidate groups shown in the two arrangements 800 and 870 in FIG. 8 correspond to, in the first arrangement 800, PDCCH candidates partitioned or grouped into six PDCCH candidate subsets, that are indexed as PDCCH subset0 810, PDCCH subset1 820, PDCCH subset2 830, PDCCH subset3 840, PDCCH subset4 850 and PDCCH subset5 860, where PDCCH candidates in two PDCCH subsets may or may not be overlapping (i.e., there may be one or more PDCCH candidates which are common to both subsets) and in the second arrangement 870, PDCCH candidates partitioned or grouped into two PDCCH candidate subsets, that are indexed as PDCCH subset0 880 and PDCCH subset1 890.

### Priority Ordering of PDCCH Candidates in a Subset

In some examples, for defined or configured subsets of PDCCH candidates, the PDCCH candidates in each subset may be pre-defined, pre-configured before operation, broadcast configuration, cell-group configuration or UE-specific configuration with a priority ordering of the PDCCH candidates to be used to carry a DCI once the PDCCH subset is activated. The priority ordering is a rule of using PDCCH candidates in the subset such that UE side may have a better idea of which PDCCH candidates may be detected first, and the UE may perform the detection in order over PDCCH candidates in the subset. The rule may be a search rule used to define how to perform searching of the PDCCH candidates.

For each PDCCH subset, the use of PDCCH candidates is prioritized with PDCCH candidate indices, where each PCCH candidate/index is directly associated/mapped to CCE index and/or indices with ALs.

One PDCCH candidate in a PDCCH subset may be configured as the first PDCCH candidate to use for transmitting scheduling or DCI control messages, for example PDCCH index 0 in the PDCCH subset.

Given PDCCH candidates and/or their indices, the usage priority and ordering for PDCCH candidates in the PDCCH subset may be determined, and this priority ordering may be used by the UE in detecting PDCCH candidates in a PDCCH subset. In some cases, the priority ordering in a PDCCH subset may be predefined or configured based on the ALs of a candidate PDCCHs. For example, for a PDCCH subset 1, the searching/usage priority of the PDCCH candidates could be candidates with AL2, candidates with AL1 and then candidates with AL4.

In one example, the priority ordering in a PDCCH subset may be based on the associated AL(s) in descending order, descending in terms of going from a larger AL value to a smaller AL value: e.g., For a PDCCH subset 1, the searching/usage priority may be AL4, AL2, AL1, as shown in FIG. 9. FIG. 9 illustrates AL4 being the first priority 910, AL2 being the second priority 920, and AL1 being the third priority 930.

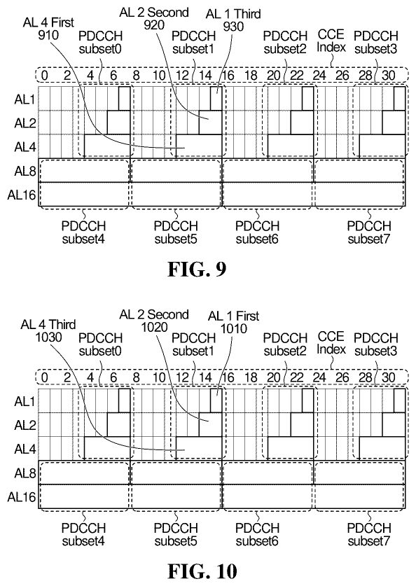

In another example, the priority ordering in a PDCCH subset may be based on the associated AL(s) in ascending order, ascending in terms of going from a smaller AL value to a larger AL value: e.g., for a PDCCH subset 1, the searching/usage priority may be AL1, AL2, AL4, as shown in FIG. 10. FIG. 10 illustrates AL1 being the first priority 1010, AL2 being the second priority 1020, and AL4 being the third priority 1030.

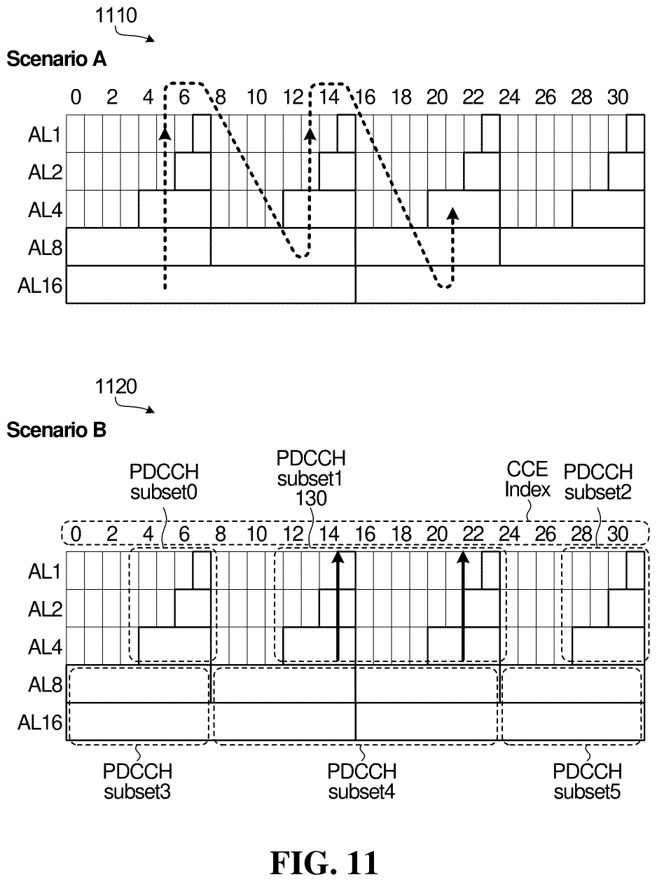

In FIG. 11, an example of a priority ordering of PDCCH candidates is shown where the AL of a candidate PDCCH is used first and the CCE index is used second in the ordering. That is, the priority goes from higher AL to lower AL with a lower CCE index, and then from higher AL to lower AL with a higher CCE index and so forth. Note that scenario a) shown in FIG. 11 may be a single set of PDCCH candidates with such a priority ordering on these PDCCH candidates.

In scenario a) 1110 of FIG. 11, as there is a single set of PDCCH candidates, the ordering follows the ordering of 1) AL16, CCE0, 2) AL8, CCE0, 3) AL4, CCE4, 4) AL2, CCE6, 5) AL1, CCE7, 6) AL8, CCE8, 7) AL4, CCE12, 8) AL2, CCE14, 9) AL1, CCE15, 10) AL16, CCE16, 11) AL8, CCE16, 12) AL4, CCE20, 13) AL2, CCE22, 14) AL1, CCE23, 15) AL8, CCE24, 16) AL4, CCE28, 17) AL2, CCE30, and 18) AL1, CCE31.

In scenario b) 1120 of FIG. 11, as there are five subsets of PDCCH candidates and PDCCH subset1 1130 is of interest, the ordering follows the ordering of 1) AL4, CCE12, 2) AL2, CCE14, 3) AL1, CCE15, 4) AL4, CCE20, 5) AL2, CCE22, and 6) AL1, CCE23.

Alternatively, in some embodiments, the ordering of the CCE indexes may be reversed, i.e., from higher CCE index(es) to lower CCE index(es), each with an AL ordering.

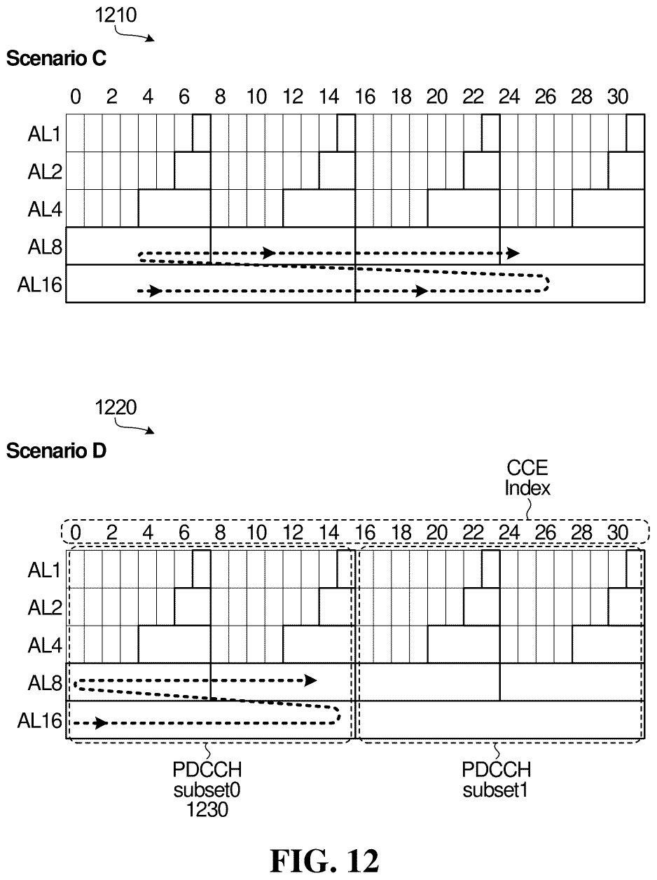

In FIG. 12, an example of a priority ordering of PDCCH candidates is shown where one or more CCE index(es) of subset of candidate PDCCHs are used first and the AL of a candidate PDCCH is used second in the ordering. That is, one or more CCE indexes are used from lower to higher with a higher AL, and then one or more CCE indexes are used from lower to higher with a lower AL, and so forth. Note that scenario c), shown in FIG. 12, may be a single set of PDCCH candidates with such a priority ordering on these PDCCH candidates.

In scenario c) 1210 of FIG. 12, as there is a single set of PDCCH candidates, the ordering follows the ordering of 1) AL16, CCE0, 2) AL16, CCE16, 3) AL8, CCE0, 4) AL8, CCE8, 5) AL8, CCE16, 6) AL8, CCE24, 7) AL4, CCE4, 8) AL4, CCE12, 9) AL4, CCE20, 10) AL4, CCE28, 11) AL2, CCE6, 12) AL2, CCE14, 13) AL2, CCE22, 14) AL2, CCE30, 15) AL1, CCE7, 16) AL1, CCE15, 17) AL1, CCE23, and 18) AL1, CCE31.

In scenario d) 1220 of FIG. 12, as there are two subsets of PDCCH candidates and PDCCH subset0 1230 is of interest, the ordering follows the ordering of 1) AL16, CCE0, 2) AL8, CCE0, 3) AL8, CCE8, 4) AL4, CCE4, 5) AL4, CCE12, 6) AL2, CCE6, 7) AL2, CCE14, 8) AL1, CCE7 and 9) AL1, CCE5.

Alternatively, the ordering of the CCE index(es) may be reversed, i.e., from higher CCE index(es) to lower CCE index(es) each with an AL ordering.

In some cases, the priority ordering of different subsets of PDCCH candidates may be predefined or configured using, for example, the subset indices. In this case, a subset of PDCCH candidates may be determined to be used first and the PDCCH candidates in the subset may follow the priority of usage described in FIG. 11 or FIG. 12.

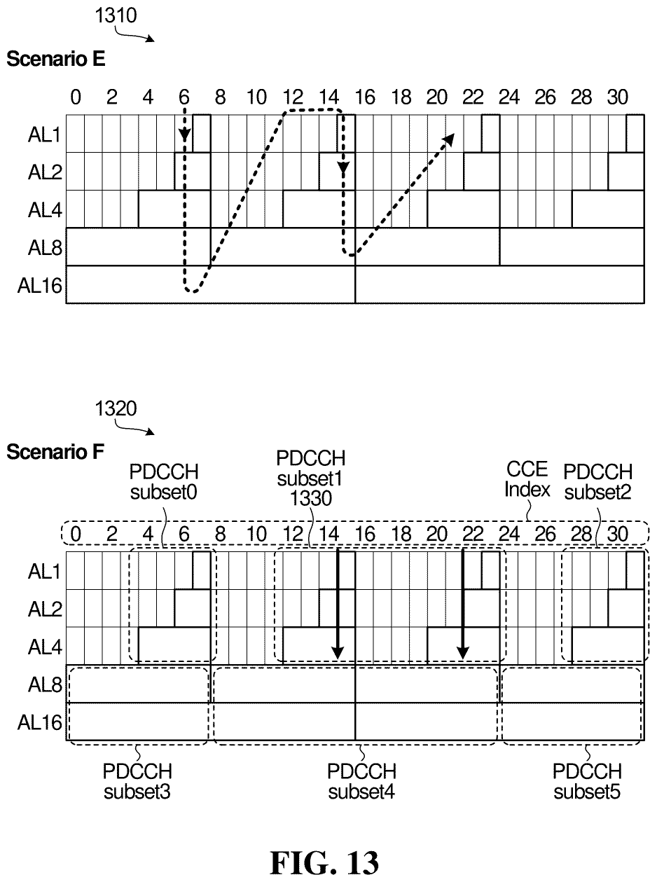

In FIG. 13, a priority ordering of PDCCH candidates is shown where AL is used first and a CCE index used second in the ordering. That is, the priority ordering goes from lower AL to higher AL with lower CCE index, and then from lower AL to higher AL with higher CCE index, and so forth. Note that scenario e), in FIG. 13, may be a single set of PDCCH candidates with such a priority ordering on the PDCCH candidates.

In scenario e) 1310 of FIG. 12, as there is a single set of PDCCH candidates, the ordering follows the ordering of 1) AL1, CCE7, 2) AL2, CCE6, 3) AL4, CCE4, 4) AL8, CCE0, 5) AL16, CCE0, 6) AL1, CCE15, 7) AL2, CCE14, 8) AL4, CCE12, 9) AL8, CCE8, 10) AL1, CCE23, 11) AL2, CCE22, 12) AL4, CCE20, 13) AL8, CCE16, 14) AL16, CCE16, 15) AL1, CCE31, 16) AL2, CCE30, 17) AL4, CCE28, and 18) AL8, CCE24.

In scenario f) 1320 of FIG. 13, as there are two subsets of PDCCH candidates and PDCCH subset1 1330 is of interest, the ordering follows the ordering of 1) AL1, CCE15, 2) AL2, CCE14, 3) AL4, CCE12, 4) AL1, CCE23, 5) AL2, CCE22, and 6) AL4, CCE20.

Alternatively, the ordering of the CCE indexes may be reversed, i.e., from CCE higher index(es) to lower index(es), each with an AL ordering.

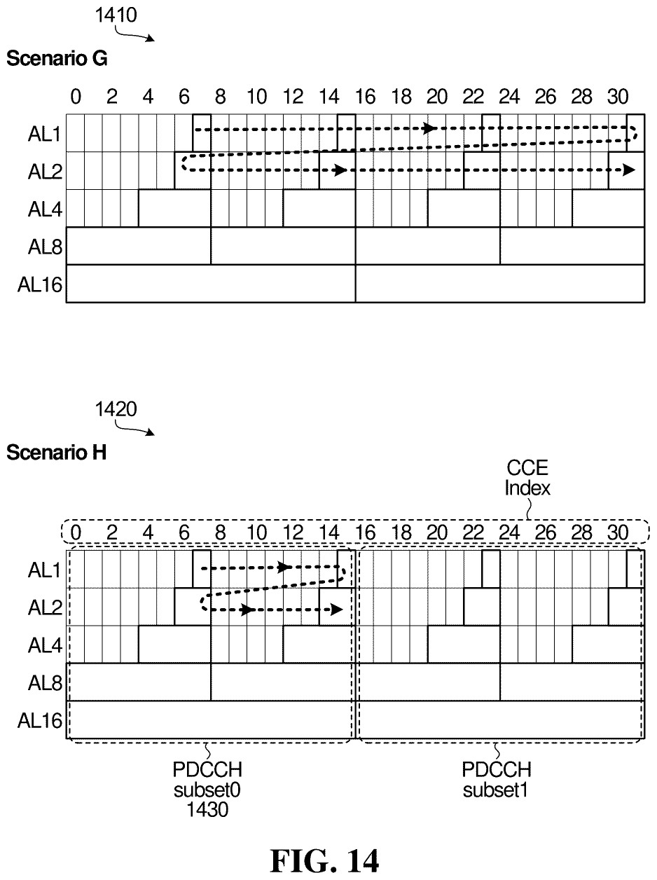

In FIG. 14, a priority ordering of PDCCH candidates is shown where one or more CCE indexes are used first and AL is used second in the ordering. That is, the priority ordering goes from lower CCE index(es) to higher CCE index(es) with lower AL, and then from lower CCE index(es) to higher CCE index(es) with higher AL, and so forth. Note that scenario g), shown in FIG. 14, may be a single set of PDCCH candidates with such a priority ordering on the PDCCH candidates.

In scenario g) 1410 of FIG. 14, as there is a single set of PDCCH candidates, the ordering follows the ordering of 1) AL1, CCE7, 2) AL1, CCE15, 3) AL1, CCE23, 4) AL1, CCE31, 5) AL2, CCE6, 6) AL2, CCE14, 7) AL2, CCE22, 8) AL2, CCE30, 9) AL4, CCE4, 10) AL4, CCE12, 11) AL4, CCE20, 12) AL4, CCE28, 13) AL8, CCE0, 14) AL8, CCE8, 15) AL8, CCE16, 16) AL8, CCE24, 17) AL16, CCE0, and 18) AL16, CCE16.

In scenario h) 1420 of FIG. 14, as there are two subsets of PDCCH candidates and PDCCH subset0 1430 is of interest, the ordering follows the ordering of 1) AL1, CCE7, 2) AL1, CCE15, 3) AL2, CCE6, 4) AL2, CCE14, 5) AL4, CCE4, 6) AL4, CCE12, 7) AL8, CCE0, 8) AL8, CCE8, and 9) AL16, CCE0.

Alternatively, the ordering of the CCE index(es) may be reversed, i.e., from CCE higher index(es) to lower index(es) each with an AL ordering.

In some cases, the priority ordering of different subsets of PDCCH candidates may be predefined or configured using, for example, the subset indices. In this case, a subset of PDCCH candidates may be determined to be used first and the PDCCH candidates in the subset may follow the priority of usage described in FIG. 13 or FIG. 14.

### UE CSI Reporting or Indication

To potentially reduce the amount of blind detection performed by a UE to determine a PDCCH, part of all available PDCCH channels may be formed as a subset of PDCCH candidates that are associated with ALs, where the subset of the PDCCH candidates may be mapped to channel conditions and quality. One of multiple subsets of PDCCH candidates may be indicated as active to use at a point in time or within a period of time and switching between different subsets of PDCCH candidates may be triggered by channel conditions and quality that are measured on DL or/and UL reference signals and indicated by, e.g., one or more of RRC, MAC-CE, or DCI. Within a subset of PDCCH candidates, a PDCCH candidate usage ordering may be (pre-)defined or (pre)configured to further reduce the blind detection. The crucial issue here is the channel conditions and quality that have to be used to determine appropriate AL(s) and other transmission parameters such as, e.g., one or more of transmission power, MCS, numerology options, transceiver types, antenna and beam forming configurations, transmission duplexing (e.g., TDD, FDD, half duplexing, full duplexing, etc.), and signal waveforms for transmission.

Channel conditions and quality may be measured by measurement metrics, including, e.g., RSRP, RSRQ, SINR, etc., based on DL or/and UL reference signals such as, e.g., SSB, CSI-RS, SRS. For example, the channel measurement(s) on DL RS(s), such as, e.g., SSB or CSI-RS, received by a UE, may be used for a decision on one or more accurate aggregation level(s) used for a PDCCH to reliably carry the scheduling information or DCI. An RSRP is the average power received from a single reference signal and its typical range is between −44 dbm (good) to −140 dbm (bad). An RSRQ indicates the quality of the received signal and its range is typically between −19.5 dB (bad) to −3 dB (good). An SINR is the signal-to-noise ratio of the given signal.

The UE measurements may be reported to a BS as a request, including, for example, raw CSI-reporting, an indication of channel conditions and quality, an indication of a subset of CCCs (e.g., an index identification of the subset of CCCs), or/and an indication of AL(s). The measurements reported to the BS may be used by the BS to determine a priority ordering of PDCCH candidates that matches the ordering to be used by the UE in determining the PDCCH. Thus, the UE may have at least four different ways (i.e., raw CSI-reporting, an indication of channel conditions and quality, an indication of a subset of CCCs (e.g., an index identification of the subset of CCCs), or/and an indication of AL(s)) to notify the BS of channel conditions and quality that may be used for determining an appropriate PDCCH to reliably carry a DCI to the UE (or a group of UEs). Moreover, a notification message from the UE to inform the network of measurement(s) (e.g., specific metrics are described in the next paragraph below) for determining PDCCH candidate(s) may be included or piggybacked in at least one of the following UL control channels or data channels: 1) physical uplink control channel (PUCCH), which is usually used for, e.g., feedback, measurement report, etc.; 2) scheduling request (SR) e.g., occurring when a UL transmission is needed; 3) buffer status report (BSR), where the UE reports its buffer traffic size to the network on a scheduling request for transmission; 4) UL data channel (with grant based or configured grant resources), where the notification message may be piggybacked with the data transmission; 5) Random Access Channel (RACH) process, where the notification message may be indicated by a preamble, carried by Message 3 in 4-step RACH, or carried by Message A in 2-step RACH. The notification message may be transmitted in an RRC connected state or in RRC non-connected state (e.g., Inactive or Idle state) using at least one or more of the above five schemes. The above-identified control or data channels may be configured semi-statically via a higher signaling such as RRC or indicated dynamically via a Layer-1 (L1) signal such as DCI.

A tabulated configuration of the above may comprise a set of categorized measured channel conditions based on one or more of the measurement metrics, where one categorized channel condition (or a channel condition range) corresponds to a group of one or more ALs, and one measurement metric may comprise at least one of RSRP, RSRQ and SINR. The measurement metric may also comprise at least one of SSB RSRP, SSB RSRQ, or SSB SINR.

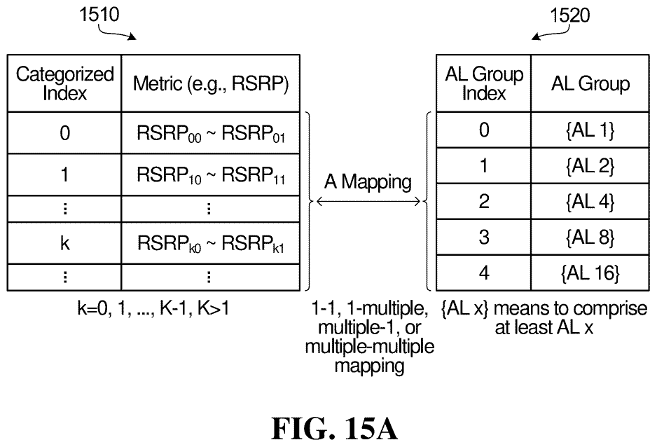

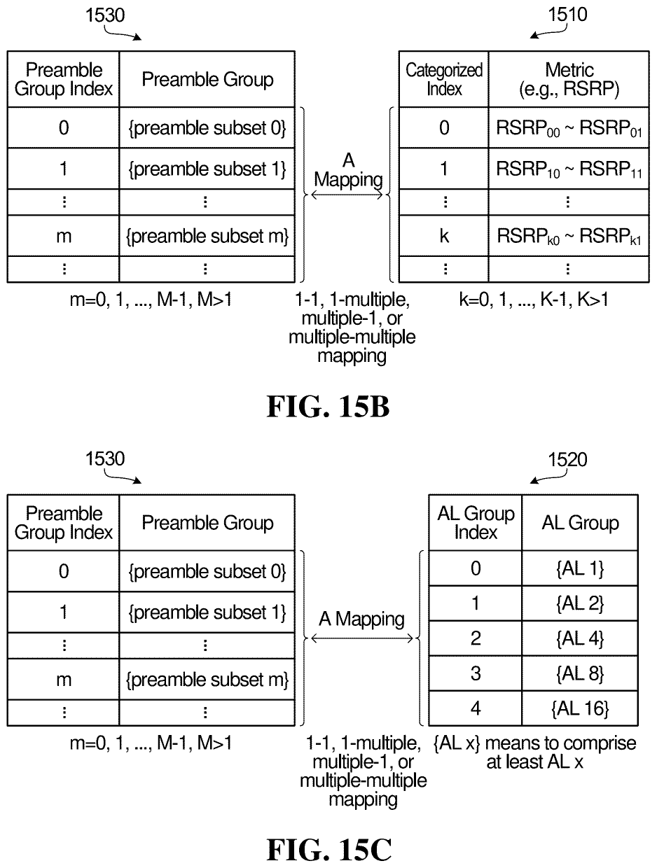

FIG. 15A illustrates an example mapping between a channel measurement, or an index value associated with the channel measurement, and a group of AL(s) for PDCCH transmission, or an index value associated with the group of AL(s).

In an example shown in FIG. 15A, RSRP values are categorized into K groups, where the categorization k of RSRP is configured with a range of value: RSRPₖ₀~RSRPₖ₁, k=0, 1, . . . , K−1, and a measured RSRP may belong to one of the K categorized groups. More generally, K may be an integer greater than or equal to 1. An example of how each RSRP value may be indexed is described in a metric table 1510 (e.g., each RSRP range is associated with one of the categorized indices 0 to K−1, as shown in the metric table 1510). The aggregation levels AL1, AL2, AL4, AL8 and AL16 are categorized into five AL groups, where one group may comprise at least one AL. In other words, {AL x} may indicate that the AL group to which {AL x} belongs include at least AL x, where “x” indicates the aggregation level, e.g., 1, 2, 4, 8, or 16. For example, {AL1} belonging to AL group 0 may comprise AL1 and optionally, AL2 and/or other ALs; {AL2} belonging to AL group 1 may comprise AL2 and optionally, AL3 and/or other ALs; . . . ; {AL16} belonging to AL group 4 may comprise AL16 and optionally, AL8 and/or other ALs. An example of how each AL group may be indexed is described in an AL table 1520 (e.g., each AL group is associated with an AL group index, as shown in the AL table 1520). An element from one table (e.g., metric table) may map to an element of the other table (e.g., AL table) according to one of the following relationships: one-to-one mapping, multiple-to-one mapping, one-to-multiple mapping, and multiple-to-multiple mapping. The metric table and the AL table may be the metric table 1510 and the AL table 1520, respectively. The mapping relationship may be expressed in terms of element indexing, for example, categorized index 0 or 1 may be mapped to AL group index 0 (in such a case, it is multiple-to-1 mapping). It may be noted that in the present disclosure, map, mapping, or mapping relationship may be interchangeably used with associate, association, association relationship, or other similar expressions. For example, a mapping between a first element from a metric table and a second element from an AL table may be also understood as an association between a first element from a metric table and a second element from an AL table. In another example, a one-to-one mapping may be also understood as a one-to-one association.

Each categorized or grouped table may be pre-defined or pre-configured and a mapping relationship between one element with a categorized index in a metric table and an element with an AL group index in an AL group table may be pre-defined, pre-configured and/or configured by broadcast (e.g., system information, SSB, etc.), cell common signaling or UE specific signaling (e.g., RRC). Using these two tables and associated mapping, the UE may make a recommendation or request to a base station based on the DL channel measurement, for a group of AL(s) that are configured for one or more PDCCH candidates in a search space, among which one PDCCH may be selected from and used for transmitting a DCI.

A mapping relationship may be in terms of element indexing, for example, categorized index 0 or 1 may be mapped to AL group index 0 (in such a case, it is a multiple-to-1 mapping). Moreover, the mapping here may have one of the following types of mapping relationships: one-to-one mapping, multiple-to-one mapping, one-to-multiple mapping, and multiple-to-multiple mapping.

Thus, in some embodiments, a UE may determine a measurement metric associated with channel conditions or quality, along with a table such as table 1510 of FIG. 15A, to get a categorization index from 1 to k (where k=0, 1, . . . K−1, K>1). The categorization index may be mapped to at least one AL group index from table 1520 which corresponds to an AL group {AL x}. In some embodiments, the AL group index may be implicitly or explicitly communicated to a BS, as described below. The BS may use mapping tables, such as tables 1510 and 1520, to determine the AL group {AL x}. The BS may then use a PDCCH associated with an AL included in AL group {AL x} to communicate with the UE until a new AL group is indicated. The UE need only search for a PDCCH among the PDCCH candidates of the AL group {AL x} to receive a subsequent signal from the BS.

For example, if an RSRP is measured by the UE to be RSRP₁₁, according to the exemplary table 1510 in FIG. 15A, the categorization index would be 1. Suppose categorization index 1 maps to AL group 1. Then the AL group would be {AL 2} which may include, for example, AL2 and AL4. This may be communicated to the BS, which will send subsequent signals using a PDCCH from AL2 or AL4. The UE need only search for a PDCCH among the PDCCH candidates of AL 2 and AL 4.

One of the advantages of using a mapping scheme such as those shown in FIG. 15A is that a UE may communicate with a base station about the DL channel conditions or quality such that there is a smaller number of PDCCH candidates, for example with AL4, AL8 or AL16, configured for a group of UEs. This may reduce the amount of blind detection required by a UE. For example, with the predefined tables and mappings shown in FIG. 15A, the UE may indicate a channel condition or quality level to a base station, which may correspond to one AL or a limited number of ALs that may be used for associated PDCCH candidates. As a result, the UE may only need to try to detect PDCCH candidate(s) with AL(s) that are implicitly or explicitly indicated by the UE preamble transmission or/and by CSI reporting based on the DL measurement on RS(s). CSI reporting may include measurement metrics, including measurement information such as SSB RSRP (reference signal received power), SSB RSRQ (reference signal received quality), SSB SINR (signal to interference-plus-noise ratio), etc.

The UE may indicate a categorized index for a mapping, such as the mapping in FIG. 15A, based on the actual channel condition or quality that is measured from a DL reference signal such as an SSB or a CSI-RS; or the UE may directly send CSI reporting with actual metric value(s) (i.e., the actual measurements on a DL reference signal) without a reference to a mapping table. The UE may use PUSCH with piggybacked information or random-access channel with message 3 (in 4-step RACH procedure) or MsgA (in two-step RACH procedure) to indicate the channel conditions or/and quality that was measured. The UE notifying the base station of the channel conditions or quality may achieve a consensus between the UE and the base station, in an implicit way, on what ALs to use for PDCCH transmission. This may reduce the amount of blind detection performed by a UE.

### Indication of Applicable AL(s)

A UE may send an indication of aggregation level(s) that can be applicable to PDCCH candidates to a BS and expect the BS to use the indicated AL(s) in a PDCCH to carry a DCI. Such as a scheme may reduce the blind detection performed by a UE to find the PDCCH that carries a DCI. There are multiple ways of indicating ALs or AL associated information to the BS, including the following:

Direct indication of AL(s): Based on measurement(s) and a categorized metric, such as that shown in FIG. 15A, a direct indication of applicable AL(s) may be sent to a BS. The mapping in the tables of FIG. 15A may have one of the following types of mapping relationships: one-to-one mapping, multiple-to-one mapping, one-to-multiple mapping, and multiple-to-multiple mapping. The mapping relationship may be expressed in terms of indexing, for example, an AL group index may be sent to the BS by the UE.

In an example shown in FIG. 15A, RSRP values are categorized into K groups, where the categorization k of RSRP is configured with a range of value: RSRPₖ₀~RSRPₖ₁, k=0, 1, . . . , K−1, and a measured RSRP may belong to one of the K categorized groups. More generally, K may be an integer greater than 1. An example of how each RSRP value may be indexed is described in a metric table 1510 (e.g., each RSRP range is associated with one of the categorized indices 0 to K−1, as shown in the metric table 1510). The aggregation levels AL1, AL2, AL4, AL8 and AL16 are categorized into five AL groups, where one group may comprise at least one AL. In other words, {AL x} may indicate that the AL group to which {AL x} belongs include at least AL x, where “x” indicates the aggregation level, e.g., 1, 2, 4, 8, or 16. For example, {AL1} belonging to AL group 0 may comprise AL1 and optionally, AL 2 and/or other ALs; {AL2} belonging to AL group 1 may comprise AL2 and optionally, AL 3 and/or other ALs; . . . ; {AL16} belonging to AL group 4 may comprise AL16 and optionally, AL 8 and/or other ALs. An example of how each AL group may be indexed is described in an AL table 620 (e.g., each AL group is associated with an AL group index, as shown in the AL table 620). An element from one table (e.g., metric table) may map to at least one element of the other table (e.g., AL table) according to one of the following relationships: one-to-one mapping, multiple-to-one mapping, one-to-multiple mapping, and multiple-to-multiple mapping. The metric table and the AL table may be the metric table 1510 and the AL table 1520, respectively. The mapping relationship may be expressed in terms of element indexing, for example, categorized index 0 or 1 may be mapped to AL group index 0 (in such a case, it is multiple-to-1 mapping). It may be noted that in the present disclosure, map, mapping, or mapping relationship may be interchangeably used with associate, association, association relationship, or other similar expressions. For example, a mapping between a first element from a metric table and a second element from an AL table may be also understood as an association between a first element from a metric table and a second element from an AL table. In another example, a one-to-one mapping may be also understood as a one-to-one association.

Each categorized or grouped table may be pre-defined or pre-configured and a mapping relationship between one element with a categorized index in a metric table and an element with an AL group index in an AL group table may be pre-defined, pre-configured and/or configured by broadcast (e.g., system information, SSB, etc.), cell common signaling or UE specific signaling (e.g., RRC). Using these two tables and associated mapping, the UE may make a recommendation or request to a base station based on the DL channel measurement, for a group of AL(s) that are configured for one or more PDCCH candidates in a search space, among which one PDCCH may be selected from and used for transmitting a DCI.

During an initial access to a network, a UE may perform a random access procedure and the first UL transmission from the UE to the base station may comprise a preamble transmission, where a preamble included in the transmission is chosen from a set of preambles that are configured for random-access procedures in the base station. To allow for faster notifications or feedback to the base station about the DL channel condition or quality, a subset of the set of preambles (or a preamble group) may be used to indicate a certain level of channel condition or quality, and multiple sub-sets of the set of preambles may be used to indicate different levels of channel conditions or quality.

Note that one network may have multiple base stations and one base station may have its own set of preambles, which may be different from preambles for neighboring base stations. The preambles in a preamble set have to be orthogonal in terms of sequence correlation or cross-correlation properties to avoid or reduce mutual interference.

For example, a set of preambles that are configured for random-access procedures in the base station may be divided (grouped) into two or more subsets, each subset comprising one or more preambles, and each of the subsets of preamble(s) may be associated with or mapped to a categorized index of a measurement metric (e.g., RSRP). The mapping may be one of the following: one-to-one mapping, multiple-to-one mapping, one-to-multiple mapping, and multiple-to-multiple mapping. The mapping relationship may be expressed in terms of element indexing, for example, preamble group index 0 may be mapped to categorized index 0 or 1 in a measurement metric (in such a case, it is 1-to-multiple mapping). An exemplary mapping is shown in FIG. 15B, where the number of preamble subsets is M>1 and the number of categorizations of a metric is K>1, where the positive integer numbers M and K may or may not be the same. M may be an integer greater than 1.

FIG. 15B illustrates an exemplary mapping between a preamble group (or a preamble subset) and a channel measurement range (M and K may or may not be the same). In FIG. 15B, a set of preambles that may be configured for random-access procedures are divided into M groups, as shown in the preamble group table 1530. More generally, M may be an integer greater than 1. Each preamble group may be indexed as shown in the preamble group table 1530 (e.g., each preamble group may be associated with one of the preamble group indices 0 to M−1, as shown in the preamble group table 1530). Each of the preamble groups may be all or a subset of preambles that may be used for establishing the connection between the apparatus (e.g., UE) and the device (e.g., base station). For example, the preamble group with a preamble group index 0 may correspond to {preamble subset 0} that may comprise all or a certain subset of preambles that may be used for establishing the connection between the apparatus and the device, the preamble group with a preamble group index 1 may correspond to {preamble subset 1} that may comprise all or a certain subset of preambles that may be used for establishing the connection between the apparatus and the device, and the preamble group with a preamble group index m may correspond to {preamble subset m} that may comprise all or a certain subset of preambles that may be used for establishing the connection between the apparatus and the device, where m is an integer between 0 and M−1.

An element from the preamble group table 1530 may map to an element of a categorized channel measurement metric table (e.g., metric table 1510) according to one of the following relationships: one-to-one mapping, multiple-to-one mapping, one-to-multiple mapping, and multiple-to-multiple mapping. The metric table 1510 shown in FIG. 15B is same as the metric table 1510 described above and in FIG. 15A. It is noted that another channel measurement metric table that is different from the metric table 1510 may be mapped to the preamble group table 1530 in a similar manner.

One of the advantages of using a mapping scheme such as those shown in FIG. 15A and FIG. 15B is that a UE may communicate with a base station about the DL channel conditions or quality such that there is a smaller number of PDCCH candidates, for example with AL4, AL8 or AL16, configured for a group of UEs. This may reduce the amount of blind detection used by a UE. For example, with the predefined tables and mappings shown in FIG. 15A and FIG. 15B, the UE may indicate a channel condition or quality level to a base station, which may correspond to one AL or a limited number of ALs that may be used for associated PDCCH candidates. As a result, the UE may only need to try to detect PDCCH candidate(s) with AL(s) that are implicitly or explicitly indicated by the UE preamble transmission or/and by channel state information (CSI) reporting based on the DL measurement on RS(s), for example, via 4-step RACH or 2-step RACH procedures, where the CSI reporting may include the measurement metrics, including at least measurement information such as SSB RSRP (reference signal received power), SSB RSRQ (reference signal received quality), SSB SINR (signal to interference-plus-noise ratio), etc. The CSI reporting may instead or additionally include measurement information such as RSRP, RSRQ, and/or SINR.

Additionally, PDCCH candidates with AL1 or AL2 may be used during initial access to network instead of a higher minimum AL. According to the current scheme for initial access, the network has to transmit a PDCCH with AL4, AL8 or AL16, which may not be necessary in a method proposed in the present disclosure, if the channel condition is good enough or the UE is very close to the BS. In this case, it is proposed to also use AL1 and AL2 (resources) to transmit a PDCCH during a UE initial access to network with one or more UE measurement indications to the BS. Here, “this case” refers to the present disclosure. This may use less time-frequency resources to transmit a PDCCH and reduce the amount of blind detection used to determine the PDCCH (e.g., UE indicates to BS to use AL1 and the BS may determine to use it).

### Implicit Indication of Applicable AL(s)

A UE may use grouped preambles, UL data transmission, or a combination of thereof to indicate the channel conditions or quality to a base station, and achieve a consensus between the UE and the base station in an implicit way regarding which ALs to use for a PDCCH transmission based, for example, on the mappings shown in FIG. 15A and/or FIG. 15B.

For example, in FIG. 15B, a preamble associated with a categorized index of a measurement metric (e.g., RSRP) is selected from a subset of preambles. The subset of preambles may be one of {preamble subset 0}, {preamble subset 1}, . . . , {preamble subset m} included in the preamble group table 1530. Each preamble subset in the preamble group table 1530 may be associated with at least one of the elements in the channel measurement metric table 1510 shown in FIGS. 15A and 15B. For the purpose of illustration, it is assumed here that the preamble subset to which the selected preamble belongs is associated with one categorized index of the channel measurement metric table 1510. The categorized index of the measurement metric in turn corresponds to an element with at least one AL group index in the AL group table in FIG. 15A. For the purpose of illustration, it is assumed here that the categorized index associated with the preamble subset to which the selected preamble belongs is associated with one AL group index of the AL group table 1520 in FIG. 15A. Thus, based on configurations on FIG. 15B, the UE may transmit a preamble from a preamble group that corresponds to a categorized index in the metric (e.g., one RSRP level) based on its channel measurement; this may imply to indicate on an AL group index (i.e., AL(s) in the element) in FIG. 15A that may be used for transmitting PDCCH by a base station. Specifically, in an example with particular values, a preamble may be selected from {preamble subset m} in the preamble group table 1530. The preamble group index m may be associated with the categorized index k that corresponds to the RSRP range of RSRPₖ₀~RSRPₖ₁. The categorized index k of the channel measurement metric table 1510 may be associated with the AL group index 1 that is associated with the AL group {AL 2}. Accordingly, the preamble selected from the {preamble subset m} may implicitly indicate that the AL group {AL 2} may be used for transmission of scheduling information (e.g., DCI) over the PDCCH. It is noted that the selected preamble may be transmitted from the apparatus (e.g., UE) to the device (e.g., base station) via Message 1 (in 4-step RACH procedure) or Message A (in 2-step RACH procedure).

As another example, the UE may use a UL data transmission sent to a base station to indicate a categorized index of a measurement metric (e.g., RSRP), as shown in FIG. 15A, where selection of the categorized index is based on the actual channel condition or quality that is measured from a DL reference signal, such as an SSB. For example, the UL data transmission may include transmission of information indicative of quality of a DL reference signal (DL RS). The quality of the DL RS may be based on, for example, SSB RSRP, SSB RSRQ, and/or SSB SINR. The UE may identify one of the categorized indices 0 to K−1 in the metric table 1510 that corresponds to the measured quality of the DL RS. The UE may transmit, to the base station, the categorized index or information indictive thereof using Message 3 (in 4-step RACH procedure) or Message A (in 2-step RACH procedure).

Alternatively, the UE may use a UL data transmission to directly report CSI reporting data with actual metric value (i.e., the actual measurements on a DL reference signal) without reference to mappings such as those shown in FIG. 15A or FIG. 15B. In some embodiments, the UE may transmit any information indicative of quality of the DL RS, or a CSI report which may include at least one of RSRP, RSRQ, SINR, SSB RSRP, SSB RSRQ, or SSB SINR. In this alternative scheme, a UL data channel for the UL data transmission (to indicate or send CSI reporting) during an initial access process may be, for example, MsgA for 2-step RACH or Message 3 for 4-step RACH. MsgA may be also referred to as Message A. After the UL transmission, the base station may identify one of the categorized indices 0 to K−1 in the metric table 1510 that corresponds to the received information indicative of quality of the DL RS. The details may be provided in the following embodiments. Note that in such a scenario, there is no need to play with the preamble indication of the channel conditions or quality, which means that a legacy preamble transmission is performed in the initial access to network.

A UE may use grouped preambles or a UL data transmission to indicate the channel conditions or quality to a base station, as described above, in order to achieve a consensus between the UE and the base station, in an implicit way, regarding which ALs to use for PDCCH transmission based on, for example, FIG. 15A and/or FIG. 15B. Another option would be to combine the two indication schemes, i.e., use both the grouped preambles and UL data transmission to notify the base station on the channel conditions or quality. This may reduce the amount of blind detection used by a UE.

### Explicit Indication of Applicable AL(s)

During an initial access to network, a UE may send an indication of aggregation level(s) that may be applicable to PDCCH candidates to a BS and expect the BS to use the indicated AL(s) in a PDCCH to carry a DCI. Such a scheme may reduce the blind detection used by a UE to find the PDCCH that carries a DCI. There are multiple ways of indicating ALs or AL associated information to the BS, including the following. The indicating ALs or AL associated information to the BS may refer to the explicit indication of applicable AL(s) and is described below with reference to FIG. 15C. FIG. 15C illustrates an example mapping between a preamble group (or a preamble subset) or an index value associated with the preamble group and a group of AL(s) for PDCCH transmission or an index value associated with the group of AL(s).

Preamble indication on AL(s): a set of preambles configured for a random-access occasion in a base station may be divided (grouped) into two or more subsets, each subset comprising one or more preambles, and a subset of preamble(s) may be associated with or mapped to a categorized index of a measurement metric (e.g., RSRP) such as in FIG. 15b. For direct indication on AL(s), a subset of preamble(s) may be associated or mapped to a group of AL(s), and used to populate tables, such as those shown in FIG. 15c, where the mapping in the tables may be one of the following: one-to-one mapping, multiple-to-one mapping, one-to-multiple mapping, and multiple-to-multiple mapping. The mapping relationship may be expressed in terms of indexing, for example, an index on a subset of preambles may be mapped to an AL group index.

For example, a UE may select a preamble from a subset of preambles based on measurements from an SSB (e.g., channel conditions and quality), and then send the preamble to a BS. The BS may determine the AL(s) indicated by the preamble based on a mapping such as the mapping shown in FIG. 15c, which also indicate the channel conditions and quality observed by the UE. As a result, the BS may use a PDCCH with one of the indicated AL(s) as the PDCCH used to carry a DCI to the UE. The UE is expecting one or more PDCCHs that use the AL(s) indicated by the UE to the BS. In this way, the UE may reduce the amount of blind detection used as PDCCH candidates with the other ALs (i.e., ALs not explicitly indicated by the preamble) need not be considered. For example, based on UE channel measurement on SSB, the channel is perfect, so the UE may use a preamble in preamble subset 0 to indicate a BS that AL 1 may be used, when the preamble is received by the BS, the BS knows that the preamble is from the preamble subset 0 based on configuration of FIG. 15c, so the BS may determine to use AL1 to transmit PDCCH (which is the UE has indicated using the preamble and is expected to detect PDCCH with AL1 (allocation).

Put another way, in an example using particular values in the preamble group table 1510 and the AL group table 1520 shown in FIG. 15c, the UE may select a preamble to use from the preamble group {preamble subset 0}. The preamble group table 1530 and the AL group table 1520 in FIG. 15c may be the same as those described above and in FIGS. 15a and 15c. The preamble group {preamble subset 0} may correspond to the categorized index 0 that corresponds to the RSRP range of RSRP00~RSRP01 in which the RSRP measured on the DL RS is included. The selected preamble may be transmitted from the UE to the base station via Message 1 (in 4-step RACH procedure) or Message A (in 2-step RACH procedure). The base station may identify the AL group index 1 based on the received preamble, the preamble group table 1530, the AL group table 1520, and/or the mapping between the preamble group table 1530 and the AL group table 1520. Then, the base station may use one of the candidate PDCCHs with {AL 1} corresponding to the AL group index 1 (i.e., AL groups that comprises at least AL1) to transmit scheduling information (e.g., DCI) to the UE. For the purpose of illustration, it is here assumed that the {AL 1} comprises only AL 1. The UE may monitor only PDCCH candidates having AL 1.

UL data indication on ALs: Instead of using a preamble to indicate the intended AL(s) as described above, an AL group index may be sent via a UL data channel during the initial access to a base station, e.g., using MsgA in 2-step RACH or Message 3 in 4-step RACH. MsgA may refer to Message A. More details are provided below. Such a scheme may reduce the amount of blind detection used by the UE to determine the PDCCH that carries a DCI.

An indication of applicable AL(s) may be sent via a UL data channel or a random access message, such as, for example, MsgA in 2-step RACH or Message 3 in 4-step RACH.

A mapping between components of the tables in FIGS. 15a, 15b, or 15c may be predefined, preconfigured or configured semi-statically, e.g., RRC, MAC-CE (Medium Access Control-Control Element). More generally, indication information used for determining the information indicative of the AL group (e.g., mapping between the elements in tables 1510 and 1520) may be predetermined or received via system information or a RRC signaling. A mapping may be indexed, where a mapping index can be indicated dynamically,

### Detecting or Identifying a Control Channel

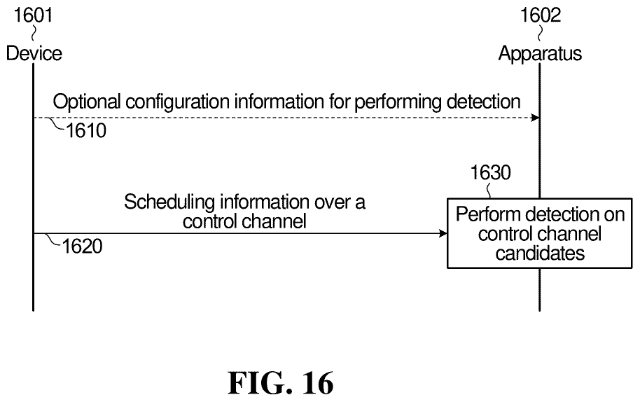

FIG. 16 is a signal flow diagram illustrating an example method for detecting or identifying a control channel used to transmit scheduling information in a wireless network including a device 1601, such as a base station (when in a downlink scenario) and an apparatus 1602, such as a user equipment (when in a downlink scenario), in accordance with embodiments of the present disclosure. More generally, the device may be considered a transmitting device, e.g. a device that is transmitting configuration information, and the apparatus may be a receiving device, e.g. a device that is receiving the configuration information.

The example process 1600 is comprised of steps 1610, 1620, and 1630. Some of the steps may be optional. It should be understood that, in some embodiments, the order of one or more steps 1610, 1620, and 1630 may be differ from that should in FIG. 16.

At step 1610, the device 1601 transmits and the apparatus 1602 receives configuration information including one or more subsets of control channel candidates (CCCs), wherein each subset of CCCs comprises one or more CCCs and wherein each subset of CCCs is located within a time-frequency resource region of a control resource set (CORESET). The configuration information in step 1610 may be sent via semi-static signaling such as system information, paging, or higher-layer signaling/RRC signaling on available CCCs and/or subsets of CCCs.

As mentioned above, a PDCCH is a type of control channel and a PDCCH candidate is a type of CCC. These terms are used interchangeably herein and it is to be understood that any reference made to a PDCCH may apply to control channels in general and vice verso. Similarly, any reference made to PDCCH candidates may apply to CCCs in general and vice versa.

For further clarity of the terms used above, it should be understood that a with the CORESET there may be a plurality of CCCs, where each CCC is comprised of a plurality of control channel elements (CCEs). The number of CCEs in a CCC may also define an aggregation level of the CCC. A subset of CCCs may be comprised of one or more CCC. There may be multiple different subsets of CCCs such that a given subset of the multiple subsets can be indicated to a device so that the device can perform blind detection on the CCCs in the subset of CCCs.

At step 1620, the device 1601 transmits and the apparatus 1602 receives indication information (e.g. a DCI) comprising a scheduling message, wherein the indication information is carried by at least one CCC of a subset of CCCs from the one or more subsets of CCCs, and the scheduling message includes scheduling resources for communication between the device 1601 and apparatus 1602. To receive the indication information, the apparatus 1602 may perform blind detection of the CCCs in an attempt to find the one or more CCCs that has the indication information for the apparatus 1602 (to be described in further detail in step 1630). Aspects of the disclosure include methods for reducing the number of blind detections of the plurality of CCCs. In some embodiments, the CCC may include or be allocated one or more CCEs as the channel resource, and each CCE has an index value. In addition, the number of CCEs in the CCC may identify an aggregation level (AL) of the CCC.

At step 1630, the apparatus 1602 performs detection of the indication information on at least one CCC of a subset of CCCs of the plurality of CCCs to identify a scheduling message. In some embodiments, the at least one CCC of the subset of CCCs is allocated in terms of one or more control channel elements (CCEs) of a group of CCEs. The group of CCEs may be defined within the resource region of the CORESET. The CCEs in the group of CCEs are mutually non-overlapping time-frequency resources. Furthermore, each CCE has a CCE index, that the respective CCEs may be identified by. In some embodiments, each of the one or more subset of the CCCs is associated with an identifier to identify the subset of the CCCs. In some embodiments, each CCC is a physical downlink control channel (PDCCH) candidate.

In some embodiments, the scheduling message, which is part of the indication information in step 1620 is downlink control information (DCI) in a PDCCH. When receiving a DCI, because the cyclic redundancy code (CRC) of the DCI is scrambled using a UE cell-based identity, e.g., C-RNTI, (Cell Radio Network Temporary Identifier) the UE may use the UE identity to descramble the CRC to validate the CRC, thus enabling the UE to figure out if the PDCCH candidate is the PDCCH that is carrying the DCI intended for the UE.

In some embodiments, additional configuration information or indication information in the form or an identification of at least one subset of the one or more subset of the CCCs may be pre-defined, broadcast, cell-group configured or UE-specific configured as a default subset to be used as an initial subset of CCCs for detection or for a fallback scenario. When an identification of at least one subset of the one or more subset of the CCCs is configured, the identification of the at least one subset is configured by a higher-layer signaling or by dynamic signaling. When at least one subset of the one or more subset of the CCCs is configured by the device 1601, the configuration information may be, for example, transmitted from the device 1601 to the apparatus 1602 as part of configuration information at optional step 1610.

In some embodiments, the one or more subset of CCCs is an active subset, and any CCC in the one or more subset of CCCs is used for carrying the scheduling message.

In some embodiments, the one or more subset of CCCs is predefined to be an active subset.

In some embodiments, when a first subset of CCCs is activated, a second subset of CCCs may also be activated, so the apparatus may use the activated second subset of CCCs to attempt to decode the scheduling information.

In some embodiments, the apparatus may receive an indication to activate a second subset of the plurality of CCCs. Then the apparatus may perform detection of the configuration information or the indication information on at least one CCC of the second subset of CCCs of the plurality of CCCs to identify the scheduling message. When the indication is received at the apparatus 1602, the indication may be, for example, transmitted from the device 1601 to the apparatus 1602 as part of configuration information at optional step 1610.

In some embodiments, upon receiving the second subset of the plurality of CCCs, which is different from the subset of the plurality of CCCs, after a time duration from reception of the indication, switching, by the receiving device, from attempting to detect a channel candidate in the subset of the plurality of CCCs to attempting to detect a channel candidate in the second subset of the plurality of CCCs.

In some embodiments, the indication comprises an identification of the time duration, which serves as a transition period to switch from attempting to detect the channel candidate in the subset of the plurality of CCCs to attempting to detect the channel candidate in the second subset of the plurality of CCCs.

In some embodiments, any of the one or more subsets of the plurality of CCCs may be indicated as an active subset. In some embodiments, any of the one or more subsets of the plurality of CCCs may be indicated as a non-active subset.

In some embodiments, the indication may be a dynamic signaling, a higher-layer signaling, or a combination of the two.

In some embodiments, the dynamic signaling is downlink control information and the higher-layer signaling is at least one of radio resource control signaling or media access control-control element (MAC-CE).

In some embodiments, the control channel candidates could be prioritized in an attempt to reduce the amount of blind detection to be performed.

In some embodiments, the apparatus 1602 may receive second configuration information or second indication information, the second configuration information or the second indication information comprising information comprising a search rule. The apparatus may then perform the detection of the at least one CCC of the subset of CCCs to identify a scheduling message is performed on the plurality of CCCs in an order based on the search rule. The second configuration information or the second indication information may be, for example, transmitted from the device 1601 to the apparatus 1602 as part of configuration information or indication information at optional step 1610.

In some embodiments, the second configuration is dynamic signaling, a higher-layer signaling, or a combination of the two. In some embodiments, the dynamic signaling is DCI. In some embodiments, the higher-layer signaling is at least one of RRC or MAC-CE.

In some embodiments, information in the search rule is arranged in the order of: a CCE index first, and an identification of an aggregation level (AL) second; or an indication of an AL first, and a CCE index second.

While multiple types of configuration information may be described above as possibly being transmitted by the device 1601 to the apparatus 1602, it is to by understood that this various configuration information may be transmitted at different times, if and when it is used, not necessarily all together. The illustration of transmission of configuration information at step 1610 is used to generally denote that some information is provided to the apparatus to help enable the detection at step 1630 and as such should be provided before the plurality of CCCs in step 1620.

FIG. 16 is described in a generic manner such that the two devices may communicate in different scenarios, such as downlink, uplink and sidelink. In a downlink scenario, the device 1601 may be a base station and the apparatus 1602 may be a UE. In an uplink scenario, the device 1601 may be a UE and the apparatus 1602 may be a base station. In a sidelink scenario, the device 1601 may be a first UE and the apparatus 1602 may be a second UE.

Examples of apparatuses and/or devices (e.g., ED or UE and BS or network device) to perform the various methods described herein are also disclosed.

For example, a device may include a memory to store processor-executable instructions, and a processor to execute the processor-executable instructions. When the processor executes the processor-executable instructions, the processor may be caused to perform the method steps of one or more of the apparatuses and/or devices as described herein, e.g., in relation to FIG. 15. For example, the processor may cause the apparatus and/or device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

The present disclosure encompasses various examples, including not only method examples, but also other examples such as apparatus examples and examples related to non-transitory computer readable storage media. Examples may incorporate, individually or in combinations, the features disclosed herein.

Although this disclosure refers to illustrative examples, this is not intended to be construed in a limiting sense. Various modifications and combinations of the illustrative examples, as well as other examples of the disclosure, will be apparent to persons skilled in the art upon reference to the description.

Features disclosed herein in the context of any particular examples may also or instead be implemented in other examples. Method examples, for example, may also or instead be implemented in apparatus, system, and/or computer program products. In addition, although examples are described primarily in the context of methods and apparatus, other implementations are also contemplated, as instructions stored on one or more non-transitory computer-readable media, for example. Such media could store programming or instructions to perform any of various methods consistent with the present disclosure.

In this application, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

In the disclosure, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

In the disclosure, the words “first”, “second”, etc., when used before a same term (e.g., ED, or an operating step) does not mean an order or a sequence of the term. For example, the “first ED” and the “second ED”, means two different EDs without specially indicated, and similarly, the “first step” and the “second step” means two different operating steps without specially indicated, but does not mean the first step have to happen before the second step. The real order depends on the logic of the two steps.

The terms “coupled”, “coupling” or “connected” as used herein may have several different meanings depending on the context in which these terms are used. For example, as used herein, the terms coupled, coupling, or connected may indicate that two elements or devices are directly connected to one another or connected to one another through one or more intermediate elements or devices via a mechanical element depending on the particular context.

The term “receive”, “detect” and “decode” as used herein may have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive”, “detect” and “decode” may indicate different procedure at receiving side to obtain the information. In some scenarios, if an apparatus implementing a method described herein is an integrated circuit, the term “receive” may mean “input” or “obtain”, and the term “transmit” may mean “output.”

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
receiving configuration information comprising one or more subsets of control channel candidates (CCCs), wherein each subset of CCCs comprises one or more CCCs, and wherein each subset of CCCs is located within a time-frequency resource region of a control resource set (CORESET); and
receiving indication information comprising a scheduling message, wherein the indication information is carried by at least one CCC of a subset of CCCs from the one or more subsets of CCCs, and the scheduling message comprises scheduling resources for communication between a receiving device and a transmitting device.

2. The method of claim 1, wherein receiving the indication information comprising the scheduling message comprises performing detection of the at least one CCC among the subset of CCCs until the scheduling message is detected, and wherein the at least one CCC of the subset of CCCs is allocated in terms of one or more control channel elements (CCEs) of a group of CCEs, and wherein:
the group of CCEs is defined within the time-frequency resource region of the CORESET;
CCEs in the group of CCEs are mutually non-overlapping time-frequency resources; and
each CCE in the group of CCEs has a CCE index.

3. The method of claim 2, wherein the at least one CCC is comprised of at least one CCE, each CCE in the at least one CCE having an index value, and wherein a number of CCEs in a respective CCC identifies an aggregation level (AL) of the respective CCC, and wherein each of the one or more subsets of CCCs is associated with an aggregation level (AL) group, wherein the AL group includes one or more ALs, and when the AL group includes two or more ALs the ALs are different from each other.

4. The method of claim 1, further comprising:
receiving an indication to activate a second subset of CCCs from the one or more subsets of CCCs; and
receiving a second indication information comprising a second scheduling message, wherein the indication information is carried by at least one CCC of the second subset of CCCs, and the scheduling message comprises scheduling resources for communication between the receiving device and the transmitting device.

5. The method of claim 4, wherein upon receiving the second subset of CCCs, which is different from the subset of CCCs, after a time duration from reception of the indication, switching from attempting to detect a CCC in the subset of CCCs to attempting to detect a CCC in the second subset of CCCs, and wherein the indication comprises an identification or a value of the time duration, which defines a transition period to switch from attempting to detect the CCC in the subset of CCCs to attempting to detect the CCC in the second subset of CCCs.

6. The method of claim 1, further comprising:
receiving signaling information, the signaling information comprising information comprising a search rule; and
performing detection of the at least one CCC among the subset of CCCs in an order based on the search rule;
wherein information in the search rule is arranged in the order of:
a CCE index first, and an identification of an aggregation level (AL) second; or
an indication of an AL first, and a CCE index second.

7. The method of claim 1 further comprising:
receiving a reference signal;
performing measurement of the reference signal to obtain a measured reference signal; and
sending an identification of a third subset of the CCCs based on the measured reference signal, so that a remote device may use the third subset of CCCs to communicate with the receiving device.

8. An apparatus in a wireless network comprising:
at least one processor coupled to at least one computer-readable medium having stored thereon computer executable instructions, that when executed by the at least one processor cause the apparatus to perform operations, the operations comprising:
receiving configuration information comprising one or more subsets of control channel candidates (CCCs), wherein each subset of CCCs comprises one or more CCCs, and wherein each subset of CCCs is located within a time-frequency resource region of a control resource set (CORESET); and
receiving indication information comprising a scheduling message, wherein the indication information is carried by at least one CCC of a subset of CCCs from the one or more subsets of CCCs, and the scheduling message comprises scheduling resources for communication between the apparatus and a transmitting device.

9. The apparatus of claim 8, wherein receiving the indication information comprising the scheduling message comprises performing detection of the at least one CCC among the subset of CCCs until the scheduling message is detected, and wherein the at least one CCC of the subset of CCCs is allocated in terms of one or more control channel elements (CCEs) of a group of CCEs, wherein:
the group of CCEs is defined within the time-frequency resource region of the CORESET;
CCEs in the group of CCEs are mutually non-overlapping time-frequency resources; and
each CCE in the group of CCEs has a CCE index.

10. The apparatus of claim 9, wherein the at least one CCC is comprised of at least one CCE, each CCE in the at least one CCE having an index value, and wherein a number of CCEs in a respective CCC identifies an aggregation level (AL) of the respective CCC, and wherein each of the one or more subsets of CCCs is associated with an aggregation level (AL) group, wherein the AL group includes one or more ALs, and when the AL group includes two or more ALs the ALs are different from each other.

11. The apparatus of claim 8, wherein the operations further comprise:
receiving an indication to activate a second subset of CCCs from the one or more subsets of CCCs; and
receiving a second indication information comprising a second scheduling message, wherein the indication information is carried by at least one CCC of the second subset of CCCs, and the scheduling message comprises scheduling resources for communication between the apparatus and the transmitting device.

12. The apparatus of claim 11, wherein the operations further comprise:
upon receiving the second subset of CCCs, which is different from the subset of CCCs, after a time duration from reception of the indication, switching from attempting to detect a CCC in the subset of CCCs to attempting to detect a CCC in the second subset of CCCs, and wherein the indication comprises an identification or a value of the time duration, which defines a transition period to switch from attempting to detect the CCC in the subset of CCCs to attempting to detect the CCC in the second subset of CCCs.

13. The apparatus of claim 8, wherein the operations further comprise:
receiving signaling information, the signaling information comprising information comprising a search rule; and
performing detection of the at least one CCC among the subset of CCCs in an order based on the search rule, and
wherein information in the search rule is arranged in the order of:
a CCE index first, and an identification of an aggregation level (AL) second; or
an indication of an AL first, and a CCE index second.

14. A method comprising:
transmitting configuration information comprising a plurality of control channel candidates (CCCs), wherein each subset of CCCs comprises one or more CCCs, and wherein each subset of CCCs is located within a time-frequency resource region of a control resource set (CORESET); and
transmitting indication information comprising a scheduling information, wherein the indication information is carried by at least one CCC of a subset of CCCs from the one or more subsets of CCCs, and the scheduling information comprises scheduling resources for communication between a transmitting device and a receiving device.

15. The method of claim 14, wherein the at least one CCC of the subset of CCCs is allocated in terms of one or more control channel elements (CCEs) of a group of CCEs, wherein:
the group of CCEs is defined within the time-frequency resource region of the CORESET;
CCEs in the group of CCEs are mutually non-overlapping time-frequency resources; and
each CCE in the group of CCEs has a CCE index.

16. The method of claim 15, wherein the one or more subset of CCCs is configured as a default subset to be used as an initial subset of CCCs for detection or for a fallback scenario, and when configured, the one or more subset of CCCs is configured by a higher-layer signaling or by dynamic signaling.

17. The method of claim 14, wherein each of the one or more subsets of CCCs is associated with an aggregation level (AL) group, wherein the AL group includes one or more ALs, and when the AL group includes two or more ALs the ALs are different from each other.

18. The method of claim 14, further comprising transmitting an indication of an ordering of the CCCs in the subset of CCCs to be used by the receiving device for performing detection.

19. The method of claim 18, wherein the indication of the ordering is associated with at least one of:
a CCE index; or
an index corresponding to a CCC within the subset of CCCs.

20. The method of claim 14, further comprising:
transmitting a reference signal for measurement at a remote receiving device; and
receiving an identification of the subset of CCCs based on the reference signal measured by a remote receiving device, enabling at least one CCC the subset of CCCs to be used to send a signal on the at least one CCC.
